(19) United States
(12) Patent Application Publication
(10) Pub. No.: US 2010/0290716 A1
(43) Pub. Date: Nov. 18, 2010

(54) IMAGE PROCESSING APPARATUS AND IMAGE PROCESSING METHOD

(76) Inventors: Hirofumi MORI, Koganei-shi (JP); Takaya Matsuno, Ome-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/726,672

(22) Filed: Mar. 18, 2010

(30) Foreign Application Priority Data
May 18, 2009 (JP) 2009-120062
Jul. 10, 2009 (JP) 2009-164046
Jul. 30, 2009 (JP) 2009-178224

(51) Int. Cl. G06K 9/03

(52) U.S. Cl. 382/309

(57) ABSTRACT

An image processing apparatus decodes a coded stream to obtain pixel data, and decides a filter coefficient for each pixel data. The filter coefficient is used for filtering of the pixel data by multiplying the pixel data and pixel data located around the pixel data by filter coefficients, respectively and adding multiplication results. The image processing apparatus determines effectiveness of adaptive control of the filter coefficient to be used in the filtering, and outputs adaptively controlled filter coefficient if the effectiveness is high, or outputs the filter coefficient, which is not adaptively controlled, if the effectiveness is not high.

### CROSS-REFERENCE TO RELATED APPLICATIONS

This application is based upon and claims the benefit of priority from prior Japanese Patent Applications No. 2009-120062, filed May 18, 2009; No. 2009-164046, filed Jul. 10, 2009; and No. 2009-178224, filed Jul. 30, 2009, the entire contents of all of which are incorporated herein by reference.

### BACKGROUND

1. Field

Embodiments disclosed herein relate generally to an image processing apparatus used in a video playback device or the like.

2. Description of the Related Art

Image correction is performed by filtering each pixel of an image. The filter used in this image correction includes filter coefficients to be applied to a correction target pixel (to be referred to as a target pixel hereinafter) and neighboring pixels (to be referred to as reference pixels hereinafter) including the target pixel. The filter coefficient to be applied is switched for each pixel (for example, Jpn. Pat. Appln. KOKAI Publication No. 2008-263507).

Filter processing, i.e., convolution operations of the reference pixels may lose sharpness in edge regions depending on the shape of the filter. There exists a technique of adaptively controlling the filter coefficients in accordance with the luminance difference between the target pixel and the reference pixels. Examples are an ε filter and a bilateral filter. These filters can preserve edges such as outlines well.

However, in some filter coefficient arrays, even when the filter coefficients are adaptively controlled, the difference generated between the filter coefficients before and after the control is small. In this case, the effect of adaptive filter coefficient control is small. It is complexity to control adaptively the filter coefficient using the difference between the target pixel and the reference pixels. For this reason, in a battery-driven electronic device such as a cellular phone or personal computer, the less effective image correction may influence the operation time.

A recent common practice is to perform video correction processing when playing back a moving image on a cellular phone so as to provide a high-quality video for the user. A method is available as this time, which selects an optimum one of a plurality of filters designed in advance and applies the selected filter to improve the quality of a video of low bit rate.

In filtering, applying the selected filter near the edge boundary may cause loss of edge information or texture information. To prevent this, before application of the selected filter, the filter may be reconstructed using a filter (e.g., ε filter or bilateral filter) that preserves edge information (for example, Jpn. Pat. Appln. KOKAI Publication No. 2008-242696).

However, an image processing apparatus for performing the above-described filtering for all pixels requires an enormous amount of operations. This problem is not unique to cellular phones but is widely common to image processing apparatuses of video playback devices.

Conventionally, filter processing is performed for image correction (for example, correction of smoothing image data by removing noise). Convolution operation is known as filter processing, which multiplies a process target pixel value and neighboring pixel values by filter coefficients (weights) and obtains the sum as the output pixel value. For effective image correction, it is preferable to select appropriate filter information (e.g., filter coefficient or tap length) for each pixel.

For example, an image processing apparatus described in Jpn. Pat. Appln. KOKAI Publication No. 11-191861 generates a direction histogram based on the magnitude and direction of the pixel gradient in a block. This image processing apparatus detects the edge direction from the direction histogram, and selects, in accordance with the edge direction, filter information to be applied to the block.

However, the image processing apparatus described in KOKAI Publication No. 11-191861 considers only the edge direction but not the edge shape (e.g., edge intensity or size) to select filter information to be applied to the block. Hence, the filter information selected based on the edge direction is not necessarily appropriate for the process target block, and image quality degradation such as oversmoothing may occur. When a performance-limited image processing apparatus such as a cellular phone is to perform similar image processing, the efficiency of filter information selection processing is preferably raised from the viewpoint of, e.g., process delay and power consumption.

### SUMMARY

An image processing apparatus comprising: a decoding unit configured to decode a coded stream to obtain pixel data of pixels included in a frame; a filter coefficient deciding unit configured to obtain, for each pixel data, a filter coefficient to be used for filtering of the pixel data by multiplying the pixel data and pixel data located around the pixel data by filter coefficients, respectively, and adding multiplication results; a determination unit configured to determine, based on a filter coefficient to multiply pixel data of a target pixel of the filtering, effectiveness of adaptive control of the filter coefficient to be used in the filtering; a filter coefficient reconstruction unit configured to adaptively control and output the filter coefficient to be used for the filtering for each pixel data if the determination unit has determined that the effectiveness is high, or output the filter coefficient obtained by the filter coefficient deciding unit if the determination unit has determined that the effectiveness is not high; and a filtering unit configured to filter the pixel data using the filter coefficient output from the filter coefficient reconstruction unit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the arrangement of a mobile wireless terminal apparatus to which an image processing apparatus according to Embodiment A of the present invention is applied;

FIG. 2 is a functional block diagram showing the arrangement of the image processing function of the mobile wireless terminal apparatus shown in FIG. 1;

FIG. 3 is a flowchart for explaining the operation of the image processing function shown in FIG. 2;

FIG. 4 is a block diagram showing the arrangement of an image processing apparatus according to Embodiments B1 and B2 of the present invention;

FIG. 5 is a block diagram showing the arrangement of the filter processing unit of the image processing apparatus shown in FIG. 4;

FIG. 6 is a flowchart for explaining the operation of the image processing apparatus according to Embodiment B1;

FIG. 7 is a flowchart for explaining the operation of the image processing apparatus according to Embodiment B2;

FIG. 8 is a block diagram showing the arrangement of an image processing apparatus according to Embodiments B3 and B4 of the present invention;

FIG. 9 is a block diagram showing the arrangement of the filter processing unit of the image processing apparatus shown in FIG. 8;

FIG. 10 is a flowchart for explaining the operation of the image processing apparatus according to Embodiment B3;

FIG. 11 is a flowchart for explaining the operation of the image processing apparatus according to Embodiment B4;

FIG. 12 is a block diagram showing an image processing apparatus according to Embodiment C1;

FIG. 13 is a flowchart illustrating processing to be performed by the image processing apparatus in FIG. 12;

FIG. 14 is a block diagram showing an image processing apparatus according to Embodiment C2;

FIG. 15 is a flowchart illustrating processing to be performed by a gradient calculation pixel deciding unit in FIG. 14;

FIG. 16 is an explanatory view of a gradient calculation pixel decided by the gradient calculation pixel deciding unit in FIG. 14;

FIG. 17 is a block diagram showing an image processing apparatus according to Embodiment C3; and

FIG. 18 is a flowchart illustrating processing to be performed by a gradient calculation block subdividing unit in FIG. 17.

### DETAILED DESCRIPTION OF THE INVENTION

### Embodiment A

An image processing apparatus according to an embodiment of the present invention will be described. An example will be described below in which the image processing apparatus is applied to a cellular phone. The cellular phone has not only an original voice communication function but also a moving image playback function of playing back stored moving image data, moving image data distributed by streaming, and moving image data obtained from a television broadcast signal.

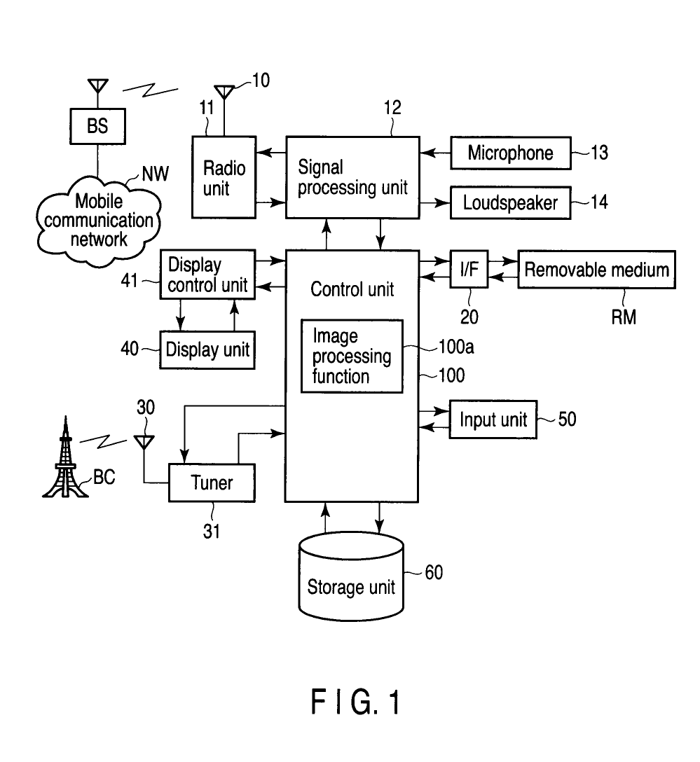

FIG. 1 illustrates an example of the arrangement of the cellular phone. The cellular phone comprises, as main constituent elements, an antenna 10, radio unit 11, signal processing unit 12, microphone 13, loudspeaker 14, external interface (I/F) 20, antenna 30, tuner 31, display unit 40, display control unit 41, input unit 50, storage unit 60, and control unit 100.

The radio unit 11 has a radio signal transmitting function and receiving function. In accordance with an instruction from the control unit 100, the transmitting function up-converts a transmitting signal output from the signal processing unit 12 to a radio frequency band, and wirelessly transmits the signal, via the antenna 10, to a base station apparatus BS accommodated in a mobile communication network NW. On the other hand, the receiving function receives, via the antenna 10, a radio signal transmitted from the base station apparatus BS, and down-converts it into a baseband signal.

The signal processing unit 12 performs transmitting signal processing and received signal processing.

In transmitting signal processing, the signal processing unit 12 modulates a carrier wave to generate the transmitting signal based on transmitting data in accordance with an instruction from the control unit 100. Note that for voice communication, a transmitting voice signal input from the microphone 13 is encoded to generate the transmitting data. When receiving a moving image distributed by streaming, the control unit 100 supplies control data to receive a coded stream. The control data is used as the transmitting data and transmitted to the distribution source.

On the other hand, in received signal processing, the baseband signal input from the radio unit 11 is demodulated to obtain received data. For voice communication, the received data is decoded, and a thus obtained received voice signal is sent to the loudspeaker 14. The loudspeaker 14 amplifies and outputs the voice signal. When receiving a moving image distributed by streaming, a coded stream is extracted from the received data and output to the control unit 100.

The external interface (I/F) 20 is an interface which physically and electrically connects a storage device such as a removable medium RM and exchanges data with it. The external interface 20 is controlled by the control unit 100. The removable medium RM can store a coded stream.

The tuner 31 receives, via the antenna 30, a television broadcast signal transmitted from a broadcast station BC, and obtains a coded stream contained in the broadcast signal. Note that moving image data obtained by encoding a moving image signal is multiplexed in the coded stream.

The display unit 40 uses a display device such as an LCD (Liquid Crystal Display) or an organic EL (Electro Luminescence) display, and can display a still image or a moving image.

The display control unit 41 drives and controls the display unit 40 in accordance with an instruction from the control unit 100, thereby causing the display unit 40 to display an image based on display data supplied from the control unit 100.

The input unit 50 comprises an input device such as a plurality of key switches (for example, so-called ten-key pad) or a touch panel, and serves as a user interface to receive a user request via it.

The storage unit 60 is a storage medium using a semiconductor memory such as a RAM (Random Access Memory) or a ROM (Read Only Memory) or using a hard disk. The storage unit 60 stores control programs and control data of the control unit 100, various kinds of data (e.g., telephone directory data) created by the user, coded streams received by the tuner 31, and control data to record coded streams in the removable medium RM.

The control unit 100 comprises a processor such as a CPU (Central Processing Unit), and comprehensively controls the units of the cellular phone. The control unit 100 has a function of controlling, e.g., voice communication, television broadcast reception, and reception of moving image data distributed by streaming. The control unit 100 also has an image processing function 100a as a function of controlling playback of moving image data. The image processing function 100a will be described later in detail. These functions are implemented by causing the processor to operate in accordance with the programs and control data stored in the storage unit 60.

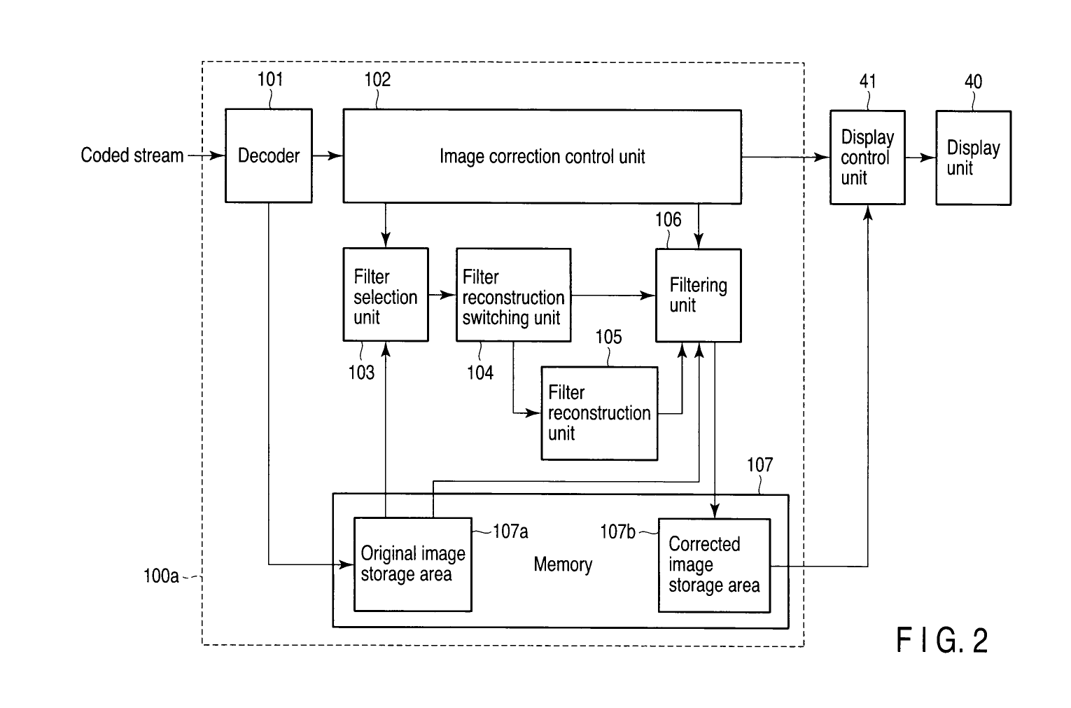

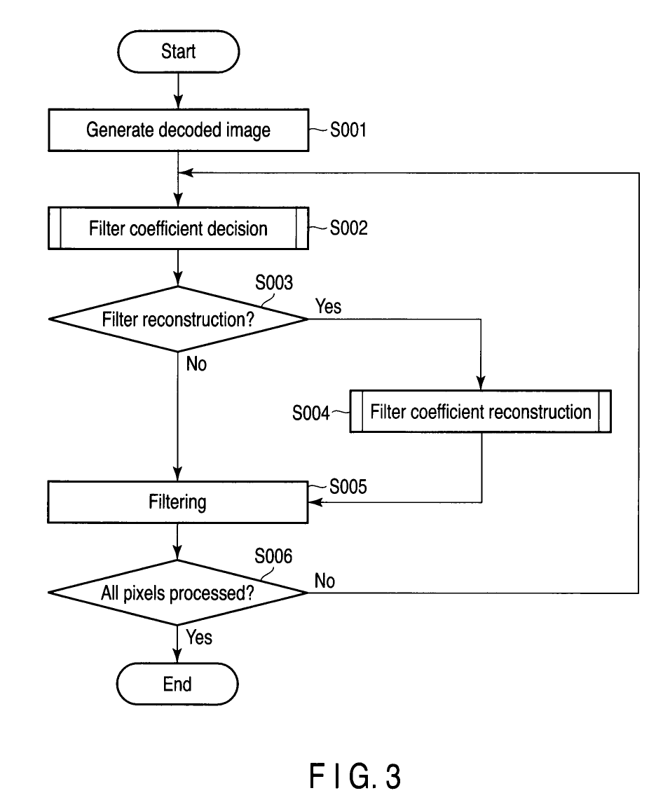

The image processing function 100a will be explained next. FIG. 2 is a block diagram showing the functions of the image processing function 100a. The image processing function 100a comprises a decoder 101, image correction control unit 102, filter selection unit 103, filter reconstruction switching unit 104, filter reconstruction unit 105, filtering unit 106, and memory 107. An operation of making these units cooperate will be described with reference to the flowchart of FIG. 3. This processing is repeatedly executed for each frame.

### (S001)

A coded stream is input to the decoder 101. The coded stream is (1) obtained by the signal processing unit 12, (2) read out from the removable medium RM via the external interface 20 by the control unit 100, or (3) received by the tuner 31. A frame encoded by a moving image encoding scheme such as MPEG-2, MPEG-4, or H.264/AVC (to be simply referred to as a frame hereinafter) is multiplexed in the coded stream.

The decoder 101 performs, for the coded stream, decoding processing corresponding to the moving image encoding scheme applied to the coded stream, thereby obtaining data of pixels (to be referred to as pixel data hereinafter) of one frame. The pixel data is expressed by, for example, YUV or RGB.

The decoder 101 records the thus obtained pixel data of one frame in an original image storage area 107a of the memory 107. After recording the pixel data in the original image storage area 107a, the decoder 101 notifies the image correction control unit 102 of a pointer value to identify the frame.

The image correction control unit 102 comprehensively controls the units of the image processing function 100a so as to make processes in steps S002 to S006 proceed for each pixel of the frame corresponding to the received pointer value.

Hence, upon detecting, based on a notification from the filtering unit 106, that filter processing has ended for all pixels of the preceding frame, the image correction control unit 102 starts the processes in steps S002 to S006 for each pixel of the frame corresponding to the pointer value received from the decoder 101. Note that if the frame is the first frame (having no preceding frame), or the process of the preceding frame has already ended, the image correction control unit 102 immediately starts the processes in steps S002 to S006.

### (S002)

Upon receiving, from the filtering unit 106, a notification representing that filter processing has ended for the preceding pixel, the image correction control unit 102 selects a pixel located at the next position in the raster scan order as a target pixel, and sends, to the filter selection unit 103, identification information to identify the target pixel.

The filter selection unit 103 reads out, from the original image storage area 107a, the pixel data of the target pixel corresponding to the identification information sent from the image correction control unit 102.

The filter selection 103 selects Cin to analyze the readout pixel data and the data of neighboring pixels near the pixel data.

Cin is served as the base of a filter coefficient Cout to be used for filter processing of the pixel data of the target pixel.

The neighboring pixels used here may be either pixel which exist in a broader range than the reference pixels, the same as the reference pixels, or pixels which exist in a narrower range than the reference pixels.

Note that the filter coefficient Cin includes filter coefficients Cin(x,y) to be applied to the reference pixels. There are a number of combinations of filter coefficient values, and one of them is selected. In this case, (x,y) represents relative coordinates with respect to the target pixel, and Cin(0,0) represents a filter coefficient to be applied to the target pixel.

In the above description, the filter selection unit 103 selects the filter coefficient Cin in accordance with the readout pixel data or neighboring pixels that exist near the pixel data. However, the filter selection unit 103 may generate the filter coefficient Cin including the filter coefficients Cin(x,y) with values corresponding to the readout pixel data or neighboring pixels that exist near the pixel data.

As a method of selecting the filter coefficient Cin, the method of patent reference 1 is available. The filter coefficients included in the filter coefficient Cin are 0 or not 0, and the sum of the filter coefficients is set to 1, as indicated by

ΣCin(x,y)=1 (1)

for all x,y

The thus selected filter coefficient Cin is sent to the filter reconstruction switching unit 104. Note that the following explanation will be made assuming that the tap length of the filter is 5×5. Since the tap length is 5×5, x and y are −2 to 2.

### (S003)

Upon receiving the filter coefficient Cin from the filter selection unit 103, the filter reconstruction switching unit 104 determines based on the received filter coefficient Cin whether it is necessary to reconstruct the filter coefficients included in the filter coefficient Cin. More specifically, the filter reconstruction switching unit 104 determines, for example, whether the filter coefficient Cin(0,0) is larger than a preset threshold THc, i.e., the ratio of the filter coefficient Cin(0,0) to the sum 1 of the filter coefficients is larger than the threshold THc.

If the filter coefficient Cin(0,0) is larger than the preset threshold THc, the filter reconstruction switching unit 104 determines that a filter with high edge preservation has already been constructed, and it is unnecessary to reconstruct the filter coefficients. If the filter coefficient Cin(0,0) is equal to or smaller than the threshold THc, the filter reconstruction switching unit 104 determines that the filter has poor edge preservation, and it is necessary to reconstruct the filter coefficients.

Upon determining that filter coefficient reconstruction processing is unnecessary, the filter reconstruction switching unit 104 notifies the filtering unit 106 of the filter coefficient Cin as the filter coefficient Cout. That is, Cin(x,y) included in the filter coefficient Cin is set as Cout(x,y). On the other hand, upon determining that filter coefficient reconstruction processing is necessary, the filter reconstruction switching unit 104 notifies the filter reconstruction unit 105 of the filter coefficient Cin.

Note that in this determination, not only the filter coefficient Cin(0,0) but also the weighted sum of Cin(x,y) (−a<x<a, −a<y<a) of the reference pixels close to the target pixel may the obtained and used for the determination.

If the filter reconstruction unit 105 uses a bilateral filter, not the filter coefficient Cin(0,0) but σ_{dis} may the used for the determination. σ_{dis} is the weight of a filter coefficient corresponding to the distance of a reference pixel. The smaller the value is, the higher the edge preservation ability of the filter is. Hence, when σ_{dis} is equal to or smaller than the threshold, it is determined that the filter coefficients of the bilateral filter need not be reconstructed.

If the filter reconstruction unit 105 uses an ε filter, the edge adaptation effect may be determined to be small, and the filter reconstruction processing may be determined to be unnecessary unless the threshold to be used in threshold determination processing of a filter coefficient for a reference pixel in the ε filter is a predetermined value or more.

### (S004)

If the filter reconstruction switching unit 104 has determined in step S003 that filter reconstruction is necessary, the filter reconstruction unit 105 reads out the pixel data of the target pixel and reference pixels from the original image storage area 107a. The filter reconstruction unit 105 executes reconstruction processing of the filter coefficient Cin based on the pixel data and neighboring pixels that exist near the pixel data. The reconstructed filter coefficients are sent to the filtering unit 106 as Cout. That is, Cin(x,y) included in the filter coefficient Cin are reconstructed to Cout(x,y). Note that the reconstruction processing executed here uses, e.g., a bilateral filter or ε filter.

### (S005)

The filtering unit 106 filters the target pixel using the filter coefficient Cout sent from the filter reconstruction switching unit 104 or the filter reconstruction unit 105. More specifically, the filtering unit 106 executes filter processing of convoluting Cout(x,y) included in the filter coefficient Cout in pixel data Src(X+x,Y+y) of each reference pixel stored in the original image storage area 107a, by

Dst(X,Y)=ΣCₒᵤₜ(x,y)·Src(X+x,Y+y) (2)

The filtering unit 106 records, in a corrected image storage area 107b of the memory 107, the pixel data that has undergone the filter processing in correspondence with the pointer value as corrected image data Dst(X,Y).

### (S006)

The filtering unit 106 notifies the image correction control unit 102 that the filter processing has ended for one pixel data. Accordingly, the image correction control unit 102 determines whether the filter processing has ended for all pixel data of the frame corresponding to the pointer value sent from the decoder 101.

If the filter processing has not ended for all pixel data, the process advances to step S002 to select a pixel located at the next position in the raster scan order as a target pixel, and sends, to the filter selection unit 103, identification information to identify the target pixel.

On the other hand, if the filter processing has ended for all pixel data, the image correction control unit 102 notifies the display control unit 41 of the pointer value. The process advances to step S001 to start processing of the next frame. Upon receiving the pointer value notification, the display control unit 41 reads out the pixel data of a frame corresponding to the pointer value from the corrected image storage area 107b, and drives and controls the display unit 40 based on the readout pixel data, thereby causing the display unit 40 to display the image.

As described above, the image processing apparatus having the above-described arrangement determines, for each pixel of a frame, the effectiveness of the ε filter or bilateral filter (the need for filter reconstruction) for preventing any failure in the playback image. Only when the filter is effective, reconstruction is performed using the filter.

Hence, according to the image processing apparatus with the above-described arrangement, it is possible to suppress less effective filter reconstruction processing. This is able to decrease the average calculation amount of processing of adaptively controlling the filter coefficients and thus reduce power consumption.

Note that the present invention is not exactly limited to the above embodiments, and constituent elements can be modified in the stage of practice without departing from the spirit and scope of the invention. Various inventions can be formed by properly combining a plurality of constituent elements disclosed in the above embodiments. For example, several constituent elements may be omitted from all the constituent elements described in the embodiments. In addition, constituent elements throughout different embodiments may be properly combined.

For example, in the above-described embodiment, the tap length of the filter is assumed to be 5×5. However, it may be 3×3 or 7×7. As the tap length of the filter becomes large, the determination in step S003 can be done more effectively by placing importance on the sum of filter coefficients near the center (target pixel).

Needless to say, the embodiment can also be practiced by making various changes and modifications without departing from the spirit and scope of the present invention.

### Embodiment B1

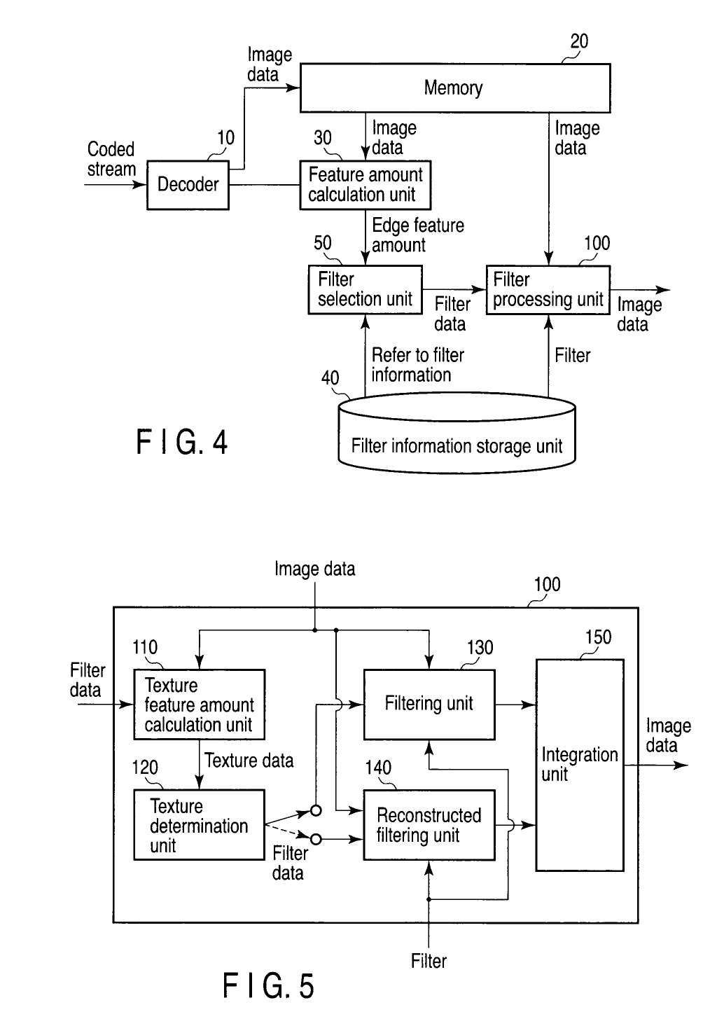

FIG. 4 shows the arrangement of an image processing apparatus according to Embodiment B1 of the present invention. The image processing apparatus comprises a decoder 10, memory 20, feature amount calculation unit 30, filter information storage unit 40, filter selection unit 50, and filter processing unit 100.

The decoder 10 receives a coded stream obtained by decoding the video signal of a moving image, and decodes the coded stream, thereby obtaining image data and encoding information of each frame. The encoding information includes quantization parameters, motion vectors, and picture information.

The memory 20 uses, for example, a semiconductor memory as a storage medium, and stores the image data output from the decoder 10.

The feature amount calculation unit 30 reads out, from the memory 20, the image data of a frame as the process target (to be referred to as a process target frame hereinafter). The feature amount calculation unit 30 divides one frame into blocks each having a predetermined size, and calculates the edge feature amount of the video for each block based on the image data. The edge feature amount obtained for each block is assigned a block index to identify the block, and output to the filter selection unit 50. Note that the feature amount calculation unit 30 may obtain the edge feature amount of each block based on the encoding information obtained by the decoder 10.

The filter information storage unit 40 stores filter information in advance by associating templates of various edge feature amounts with filters. That is, a filter to be applied to an edge feature amount is associated with the template of the edge feature amount and stored as filter information in advance. Note that the filter is a set of filter coefficients to be applied to a block including a filtering target pixel and its neighboring pixels. Applying the filter enables to obtain an output image considering the edge feature of the image.

The filter selection unit 50 refers to the filter information stored in the filter information storage unit 40, detects a filter corresponding to the edge feature amount of each block obtained by the feature amount calculation unit 30, and outputs the index of the detected filter (to be referred to as a filter index hereinafter) associated with the block index assigned to the edge feature amount to the filter processing unit 100 as filter data.

Based on the image data and the filter data, the filter processing unit 100 performs filter processing of the image data for each block of the frame. For example, the filter processing unit 100 is configured as shown in FIG. 5, and comprises a texture feature amount calculation unit 110, texture determination unit 120, Filtering unit 130, Reconstructed filtering unit 140, and integration unit 150.

Upon receiving filter data from the filter selection unit 50, the texture feature amount calculation unit 110 reads out, from the memory 20, image data corresponding to the block index contained in the filter data, and calculates a texture feature amount representing the complexity of the image of the block based on the image data. The texture feature amount calculation unit 110 outputs the texture feature amount associated with the filter data to the texture determination unit 120 as texture data.

Upon receiving the texture data from the texture feature amount calculation unit 110, the texture determination unit 120 determines, based on the texture feature amount contained in the texture data, the necessity of reconstruction of a filter based on the filter index contained in the texture data. If the texture feature amount does not exceed a threshold, i.e., if the video of the block of the process target (to be referred to as a process target block hereinafter) is monotonous, the filter data contained in the texture data is output to the Filtering unit 130. On the other hand, if the texture feature amount exceeds the threshold, i.e., if the video of the process target block is complex, the filter data is output to the Reconstructed filtering unit 140.

Upon receiving the filter data from the texture determination unit 120, the Filtering unit 130 reads out, from the filter information storage unit 40, a filter corresponding to the filter index contained in the filter data. The Filtering unit 130 also reads out, from the memory 20, image data corresponding to the block index contained in the filter data, and performs filter processing by applying the filter to the luminance value of each pixel of the block. The thus filtered image data of the block is output to the integration unit 150 together with the block index.

Upon receiving the filter data from the texture determination unit 120, the Reconstructed filtering unit 140 reads out, from the filter information storage unit 40, a filter corresponding to the filter index contained in the filter data. The Reconstructed filtering unit 140 also reads out, from the memory 20, image data corresponding to the block index contained in the filter data, reconstructs the readout filter using an ε filter for each pixel of the block based on the image data, and performs filter processing by applying each reconstructed filter to a corresponding pixel. The thus filtered image data of the block is output to the integration unit 150 together with the block index.

Upon obtaining image data that has undergone the filter processing for all blocks of the process target frame, the integration unit 150 integrates the image data filtered by the Filtering unit 130 and the Reconstructed filtering unit 140 into the image data of one frame based on the associated block indices, and outputs the image data.

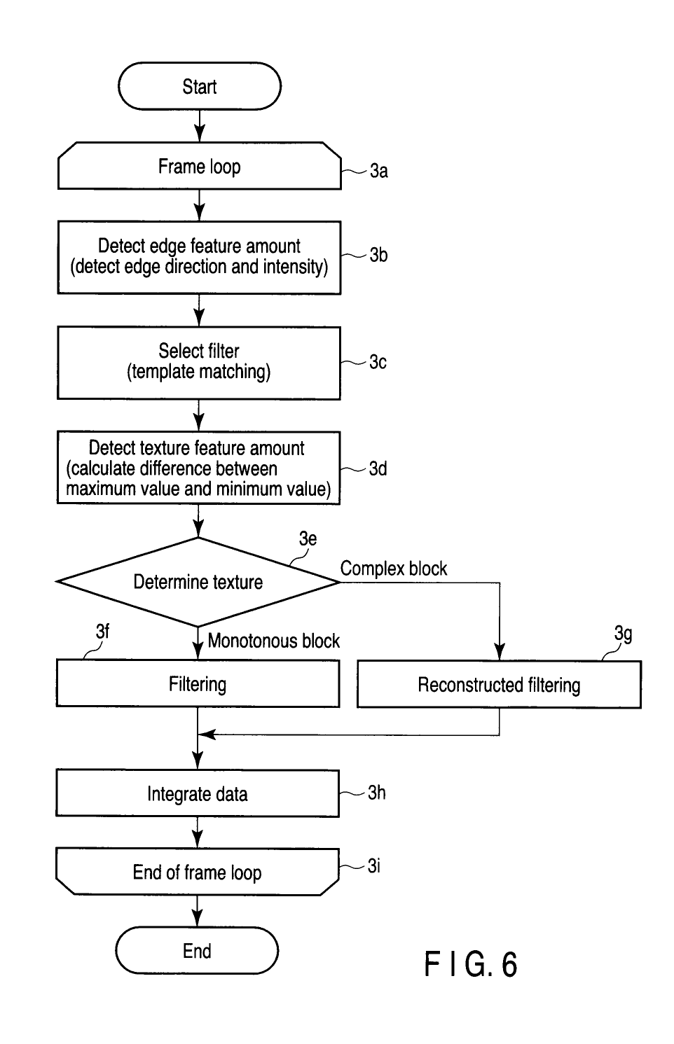

The operation of the image processing apparatus with the above arrangement will be described next. FIG. 6 is a flowchart for explaining the operation of the image processing apparatus. As shown in FIG. 6, the image processing apparatus executes frame loop control by repeating steps 3a to 3i for the image data of the respective frames stored in the memory 20.

In step 3a, the feature amount calculation unit 30 reads out the image data of the process target frame from the memory 20, and the process advances to step 3b.

In step 3b, the feature amount calculation unit 30 applies a filter such as a Sobel filter, Prewitt filter, Robinson filter, or neighborhoods-difference filter to the readout image data, thereby calculating an edge feature amount representing the edge direction or intensity of each block of the one frame. The feature amount calculation unit 30 then assigns a block index to the edge feature amount obtained for each block, and outputs it to the filter selection unit 50. The process advances to step 3c.

In step 3c, the filter selection unit 50 refers to the filter information stored in the filter information storage unit 40, performs template matching to detect a template which coincides with or is most similar to the edge feature amount of each block obtained by the feature amount calculation unit 30, and reads out a filter index corresponding to the template. The filter selection unit 50 associates the readout filter index with the block index assigned to the edge feature amount used for template matching, and outputs them to the filter processing unit 100 as filter data. The process advances to step 3d.

In step 3d, the texture feature amount calculation unit 110 reads out, from the memory 20, image data corresponding to the block index contained in the filter data received from the filter selection unit 50. Based on the image data, the texture feature amount calculation unit 110 refers to the luminance value of each pixel of the block image, detects the maximum luminance value and the minimum luminance value, and detects the difference between them as a texture feature amount representing the complexity of the image. The texture feature amount calculation unit 110 outputs the texture feature amount associated with the filter data to the texture determination unit 120 as texture data. The process then advances to step 3e.

In step 3e, the texture determination unit 120 determines, based on the texture feature amount contained in the texture data received from the texture feature amount calculation unit 110, whether it is necessary to reconstruct the filter of the filter index contained in the texture data.

More specifically, if the texture feature amount does not exceed a threshold, i.e., if the video of the block of the process target block is monotonous, the filter data is output to the Filtering unit 130, and the process advances to step 3f. On the other hand, if the texture feature amount exceeds the threshold, i.e., if the video of the process target block is complex, the filter data contained in the texture data is output to the Reconstructed filtering unit 140, and the process advances to step 3g.

In step 3f, the Filtering unit 130 reads out, from the filter information storage unit 40, a filter corresponding to the filter index contained in the filter data received from the texture determination unit 120. The Filtering unit 130 also reads out, from the memory 20, image data corresponding to the block index contained in the filter data, and performs filter processing by applying the filter to the luminance value of each pixel of the block.

More specifically, the Filtering unit 130 performs calculation represented by

$$D ( x , y ) = {\sum }_{m , n} h ( m , n ) S ( x + m , y + n ) \qquad ( 3 )$$

where (x,y) represents the coordinates of the filtering target pixel, (m,n) represents the relative coordinates with respect to the filtering target pixel and the tap length of the filter is 5×5. Since the tap length is 5×5, m and n are −2 to 2, h(m,n) is selected filter at the filtering target pixel (x,y), S(x,y) is the luminance value of the filtering target pixel, and D(x,y) is the luminance value of the filtered target pixel.

The luminance values filtered in this way are integrated into image data of each block and output to the integration unit 150 together with the block index.

On the other hand, in step 3g, the Reconstructed filtering unit 140 reads out, from the filter information storage unit 40, a filter corresponding to the filter index contained in the filter data received from the texture determination unit 120. The Reconstructed filtering unit 140 also reads out, from the memory 20, image data corresponding to the block index contained in the filter data, reconstructs the filter to be applied using an ε filter for each pixel of the block based on the image data, and performs filtering.

More specifically, the Reconstructed filtering unit 140 performs calculation represented by

$$\begin{matrix}D ( x , y ) = {\sum }_{m , n} h ( m , n ) P ( m , n ) & ( 4 ) \\ P ( m , n ) = \{ \begin{matrix}S ( x , y ) & if \vert S ( x , y ) - S ( x - m , y - n ) \vert > Th \\ S ( x - m , y - n ) & else\end{matrix} & ( 5 )\end{matrix}$$

That is, in the examples of equations, if the luminance value S(x,y) of the filtering target pixel is larger than the luminance value S(x−m,y−m) of a neighboring pixel (larger than a threshold Th), only the luminance value S(x,y) is used for filtering so as to perform the same filtering as that of a reconstructed filter. Otherwise, the same filtering as that of the Filtering unit 130 is performed.

The luminance values filtered in this way are integrated into image data of each block and output to the integration unit 150 together with the block index.

In step 3h, upon detecting that the image data of all blocks of the process target frame have been input from the Filtering unit 130 and the Reconstructed filtering unit 140, the integration unit 150 integrates these image data based on the associated block indices.

In step 3i, upon confirming that the image data of one frame has been completed by the integration in step 3h, the image data is output, and the process newly starts from step 3a for the next frame.

As described above, the image processing apparatus having the above-described arrangement does not apply the Reconstructed filtering unit 140 (ε filter) to the image data of all blocks. Instead, only when the texture feature amount exceeds the threshold, i.e., the video of the process target block is complex, the Reconstructed filtering unit 140 is applied.

Hence, according to the image processing apparatus with the above-described arrangement, since the Reconstructed filtering unit 140 is applied to only a complex block for which the filter is effective, it is possible to improve the video quality while suppressing the calculation amount.

Note that in the above embodiment, an example has been described in which the Reconstructed filtering unit 140 is an ε filter. However, the embodiment is also applicable when a bilateral filter is adopted. More specifically, when the Reconstructed filtering unit 140 is a bilateral filter, the Reconstructed filtering unit 140 performs the following processing in step 3g.

The Reconstructed filtering unit 140 reads out, from the filter information storage unit 40, a filter corresponding to the filter index contained in the filter data received from the texture determination unit 120. The Reconstructed filtering unit 140 also reads out, from the memory 20, image data corresponding to the block index contained in the filter data, reconstructs the filter to be applied using a bilateral filter for each pixel of the block based on the image data, and performs filtering.

More specifically, the Reconstructed filtering unit 140 performs calculation represented by

$$\begin{matrix}D ( x , y ) = \frac{1}{Q} {\sum }_{m , n} exp ( - \frac{{\vert S ( x , y ) - S ( x - m , y - n ) \vert}^{2}}{2 {σ}_{S ( x , y )}^{2}} ) h ( m , n ) S ( m , n ) & ( 6 ) \\ Q = {\sum }_{m , n} exp ( - \frac{{\vert S ( x , y ) - S ( x - m , y - n ) \vert}^{2}}{2 {σ}_{S ( x , y )}^{2}} ) & ( 7 )\end{matrix}$$

The luminance values filtered using the reconstructed filter in this way are integrated into image data of each block and output to the integration unit 150 together with the block index.

As described above, the embodiment is also applicable when the filter is reconstructed using a bilateral filter.

In the above-described embodiment, the texture feature amount calculation unit 110 obtains the texture feature amount based on the luminance values of pixels of the image of the process target block, as described in step 3d. The texture feature amount may be obtained based on not the luminance values but color difference signals contained in the image data.

More specifically, in step 3d, the texture feature amount calculation unit 110 reads out, from the memory 20, image data corresponding to the block index contained in the filter data received from the filter selection unit 50. Based on the image data, the texture feature amount calculation unit 110 refers to the color difference signal of each pixel of the block image, detects the maximum color difference and the minimum color difference, and detects the difference between them as a texture feature amount representing the complexity of the image. The texture feature amount calculation unit 110 outputs the texture feature amount associated with the filter data to the texture determination unit 120 as texture data. The process then advances to step 3e.

In step 3e, the texture determination unit 120 determines, based on the texture feature amount contained in the texture data received from the texture feature amount calculation unit 110, whether it is necessary to reconstruct the filter of the filter index contained in the texture data.

That is, the same effect as described above can be obtained even by obtaining the texture feature amount based on the color difference signals.

The texture feature amount calculation unit 110 may obtain the texture feature amount based on both the luminance values and the color difference signals by the above-described method. In this case, the texture feature amount calculation unit 110 obtains a first texture feature amount based on luminance values and a second texture feature amount based on color difference signals, weights them, and calculates a texture feature amount by combining the first and second texture feature amounts. The texture determination unit 120 determines the complexity of the image based on the texture feature amount.

That is, obtaining the texture feature amount based on both luminance values and color difference signals allows to more accurately determine the complexity of the image.

In the above embodiment, the texture feature amount calculation unit 110 detects the texture feature amount based on only the image data of the process target block. Instead, the texture feature amount may be obtained based on, e.g., the image data of the process target block and the image data of a past frame (a frame temporally earlier than the process target frame) at the same block position as the process target block.

In this case, the texture feature amount calculation unit 110 obtains a first texture feature amount based on the image data of the process target block and a second texture feature amount based on the image data of a block corresponding to the process target block of a past frame, weights them, and calculates a texture feature amount by combining the first and second texture feature amounts. The texture determination unit 120 determines the complexity of the image based on the texture feature amount.

That is, obtaining the texture feature amount based on both current image data and past image data allows to more accurately determine the complexity of the image.

### Embodiment B2

An image processing apparatus according to Embodiment B2 of the present invention will be described below. The arrangement of the image processing apparatus according to Embodiment B2 is apparently the same as that of the image processing apparatus according to Embodiment B1. As shown in FIG. 4, the image processing apparatus comprises a decoder 10, memory 20, feature amount calculation unit 30, filter information storage unit 40, filter selection unit 50, and filter processing unit 100.

The filter processing unit 100 of the image processing apparatus according to Embodiment B2 apparently has the same arrangement as that of the image processing apparatus according to Embodiment B1 except the process contents, and will be described with reference to FIG. 5.

More specifically, the filter processing unit 100 of the image processing apparatus according to Embodiment B2 comprises a texture feature amount calculation unit 110, texture determination unit 120, Filtering unit 130, Reconstructed filtering unit 140, and integration unit 150.

Upon receiving filter data from the filter selection unit 50, the texture feature amount calculation unit 110 reads out, from the memory 20, image data corresponding to the block index contained in the filter data, and calculates a texture feature amount representing the complexity of the image of the block based on the image data. The texture feature amount calculation unit 110 outputs the texture feature amount associated with the filter data to the texture determination unit 120 as texture data.

Upon receiving the texture data from the texture feature amount calculation unit 110, the texture determination unit 120 determines, based on the texture feature amount contained in the texture data, the necessity of reconstruction of a filter based on the filter index contained in the texture data. If the texture feature amount does not exceed a threshold, i.e., if the video of the process target block is monotonous, the filter data contained in the texture data is output to the Filtering unit 130. On the other hand, if the texture feature amount exceeds the threshold, i.e., if the video of the process target block is complex, the filter data is output to the Reconstructed filtering unit 140.

Upon receiving the filter data from the texture determination unit 120, the Filtering unit 130 reads out, from the filter information storage unit 40, a filter corresponding to the filter index contained in the filter data. The Filtering unit 130 also reads out, from the memory 20, image data corresponding to the block index contained in the filter data, and performs filter processing by applying the filter to the luminance value of each pixel of the block. The thus filtered image data of the block is output to the integration unit 150 together with the block index.

Upon receiving the filter data from the texture determination unit 120, the Reconstructed filtering unit 140 reads out, from the filter information storage unit 40, a filter corresponding to the filter index contained in the filter data. The Reconstructed filtering unit 140 also reads out, from the memory 20, image data corresponding to the block index contained in the filter data, reconstructs the readout filter using an ε filter for each pixel of the block based on the image data, and performs filter processing by applying each reconstructed filter to a corresponding pixel. The thus filtered image data of the block is output to the integration unit 150 together with the block index.

Upon obtaining image data that has undergone the filter processing for all blocks of the process target frame, the integration unit 150 integrates the image data filtered by the Filtering unit 130 and the Reconstructed filtering unit 140 into the image data of one frame based on the associated block indices, and outputs the image data.

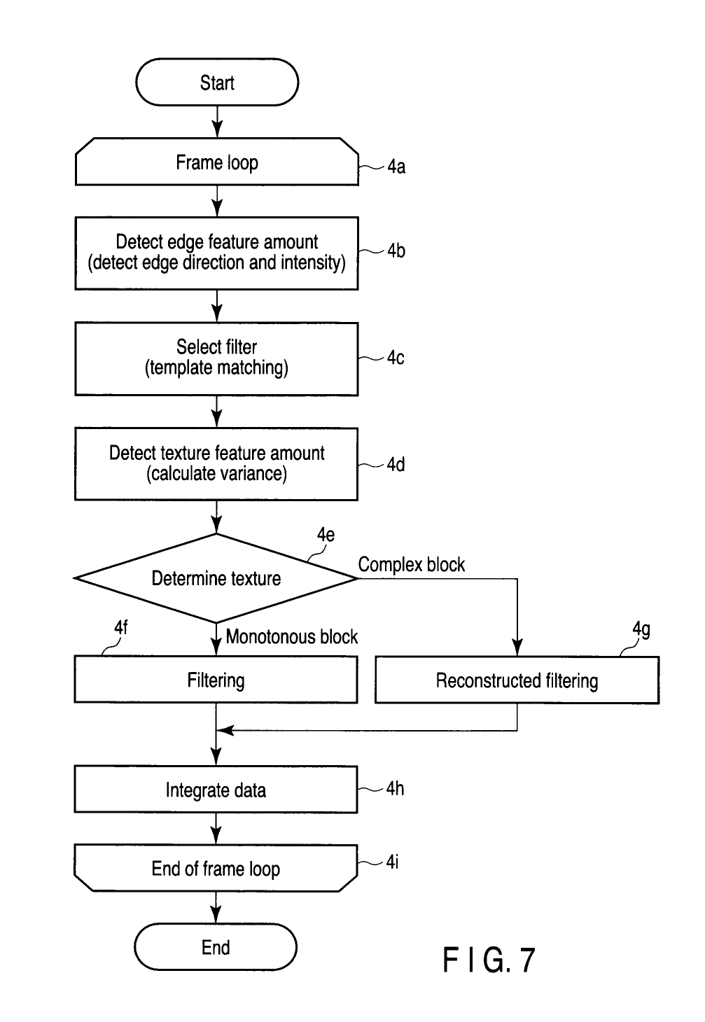

The operation of the image processing apparatus with the above arrangement will be described next. FIG. 7 is a flowchart for explaining the operation of the image processing apparatus. As shown in FIG. 7, the image processing apparatus executes frame loop control by repeating steps 4a to 4i for the image data of the respective frames stored in the memory 20.

In step 4a, the feature amount calculation unit 30 reads out the image data of the process target frame from the memory 20, and the process advances to step 4b.

In step 4b, the feature amount calculation unit 30 applies a filter such as a Sobel filter, Prewitt filter, Robinson filter, or neighborhoods-difference filter to the readout image data, thereby calculating an edge feature amount representing the edge direction or intensity of each block of the one frame. The feature amount calculation unit 30 then assigns a block index to the edge feature amount obtained for each block, and outputs it to the filter selection unit 50. The process advances to step 4c.

In step 4c, the filter selection unit 50 refers to the filter information stored in the filter information storage unit 40, performs template matching to detect a template which coincides with or is most similar to the edge feature amount of each block obtained by the feature amount calculation unit 30, and reads out a filter index corresponding to the template. The filter selection unit 50 associates the readout filter index with the block index assigned to the edge feature amount used for template matching, and outputs them to the filter processing unit 100 as filter data. The process advances to step 4d.

In step 4d, the texture feature amount calculation unit 110 reads out, from the memory 20, image data corresponding to the block index contained in the filter data received from the filter selection unit 50. Based on the image data, the texture feature amount calculation unit 110 refers to the luminance value of each pixel of the block image, calculates the variance of the luminance values, and detects the value as a texture feature amount representing the complexity of the image. The texture feature amount calculation unit 110 outputs the texture feature amount associated with the filter data to the texture determination unit 120 as texture data. The process then advances to step 4e.

In step 4e, the texture determination unit 120 determines, based on the texture feature amount contained in the texture data received from the texture feature amount calculation unit 110, whether it is necessary to reconstruct the filter of the filter index contained in the texture data.

More specifically, if the texture feature amount does not exceed a threshold, i.e., if the video of the block of the process target block is monotonous, the filter data is output to the Filtering unit 130, and the process advances to step 4f. On the other hand, if the texture feature amount exceeds the threshold, i.e., if the video of the process target block is complex, the filter data contained in the texture data is output to the Reconstructed filtering unit 140, and the process advances to step 4g.

In step 4f, the Filtering unit 130 reads out, from the filter information storage unit 40, a filter corresponding to the filter index contained in the filter data received from the texture determination unit 120. The Filtering unit 130 also reads out, from the memory 20, image data corresponding to the block index contained in the filter data, and performs filter processing by applying the filter to the luminance value of each pixel of the block.

More specifically, the Filtering unit 130 performs calculation represented by equation (3) described above.

The luminance values filtered in this way are integrated into image data of each block and output to the integration unit 150 together with the block index.

On the other hand, in step 4g, the Reconstructed filtering unit 140 reads out, from the filter information storage unit 40, a filter corresponding to the filter index contained in the filter data received from the texture determination unit 120. The Reconstructed filtering unit 140 also reads out, from the memory 20, image data corresponding to the block index contained in the filter data, reconstructs the filter to be applied using an ε filter for each pixel of the block based on the image data, and performs filtering.

More specifically, the Reconstructed filtering unit 140 performs calculation represented by equations (4) and (5) described above. That is, in the examples of equations, if a luminance value S(x,y) of the filtering target pixel is larger than a luminance value S(x−m,y−m) of a neighboring pixel (larger than a threshold Th), only the luminance value S(x,y) is used for filtering so as to perform the same filtering as that of a reconstructed filter. Otherwise, the same filtering as that of the Filtering unit 130 is performed.

The luminance values filtered in this way are integrated into image data of each block and output to the integration unit 150 together with the block index.

In step 4h, upon detecting that the image data of all blocks of the process target frame have been input from the Filtering unit 130 and the Reconstructed filtering unit 140, the integration unit 150 integrates these image data based on the associated block indices.

In step 4i, upon confirming that the image data of one frame has been completed by the integration in step 4h, the image data is output, and the process newly starts from step 4a for the next frame.

As described above, the image processing apparatus having the above-described arrangement does not apply the Reconstructed filtering unit 140 (ε filter) to the image data of all blocks. Instead, only when the texture feature amount exceeds the threshold, i.e., the video of the process target block is complex, the Reconstructed filtering unit 140 is applied.

Hence, according to the image processing apparatus with the above-described arrangement, since the Reconstructed filtering unit 140 is applied to only a complex block for which the filter is effective, it is possible to improve the video quality while suppressing the calculation amount.

Note that in the above embodiment, an example has been described in which the Reconstructed filtering unit 140 is an ε filter. However, the embodiment is also applicable when a bilateral filter is adopted. More specifically, when the Reconstructed filtering unit 140 is a bilateral filter, the Reconstructed filtering unit 140 performs the following processing in step 4g.

The Reconstructed filtering unit 140 reads out, from the filter information storage unit 40, a filter corresponding to the filter index contained in the filter data received from the texture determination unit 120. The Reconstructed filtering unit 140 also reads out, from the memory 20, image data corresponding to the block index contained in the filter data, reconstructs the filter to be applied using a bilateral filter for each pixel of the block based on the image data, and performs filtering.

More specifically, the Reconstructed filtering unit 140 performs calculation represented by equations (6) and (7) described above.

The luminance values filtered using the reconstructed filter in this way are integrated into image data of each block and output to the integration unit 150 together with the block index.

As described above, the embodiment is also applicable when the filter is reconstructed using a bilateral filter.

In the above-described embodiment, the texture feature amount calculation unit 110 obtains eth texture feature amount based on the luminance values of pixels of the image of the process target block, as described in step 4d. The texture feature amount may be obtained based on not the luminance values but color difference signals contained in the image data.

More specifically, in step 4d, the texture feature amount calculation unit 110 reads out, from the memory 20, image data corresponding to the block index contained in the filter data received from the filter selection unit 50. Based on the image data, the texture feature amount calculation unit 110 refers to the color difference signal of each pixel of the block image, calculates the variance of the color difference signals, and detects the value as a texture feature amount representing the complexity of the image. The texture feature amount calculation unit 110 outputs the texture feature amount associated with the filter data to the texture determination unit 120 as texture data. The process then advances to step 4e.

In step 4e, the texture determination unit 120 determines, based on the texture feature amount contained in the texture data received from the texture feature amount calculation unit 110, whether it is necessary to reconstruct the filter of the filter index contained in the texture data.

That is, the same effect as described above can be obtained even by obtaining the texture feature amount based on the color difference signals.

The texture feature amount calculation unit 110 may obtain the texture feature amount based on both the luminance values and the color difference signals by the above-described method. In this case, the texture feature amount calculation unit 110 obtains a first texture feature amount based on luminance values and a second texture feature amount based on color difference signals, weights them, and calculates a texture feature amount by combining the first and second texture feature amounts. The texture determination unit 120 determines the complexity of the image based on the texture feature amount.

That is, obtaining the texture feature amount based on both luminance values and color difference signals allows to more accurately determine the complexity of the image.

In the above embodiment, the texture feature amount calculation unit 110 detects the texture feature amount based on only the image data of the process target block. Instead, the texture feature amount may be obtained based on, e.g., the image data of the process target block and the image data of a past frame (a frame temporally earlier than the process target frame) at the same block position as the process target block.

In this case, the texture feature amount calculation unit 110 obtains a first texture feature amount based on the image data of the process target block and a second texture feature amount based on the image data of a block corresponding to the process target block of a past frame, weights them, and calculates a texture feature amount by combining the first and second texture feature amounts. The texture determination unit 120 determines the complexity of the image based on the texture feature amount.

That is, obtaining the texture feature amount based on both current image data and past image data allows to more accurately determine the complexity of the image.

### Embodiment B3

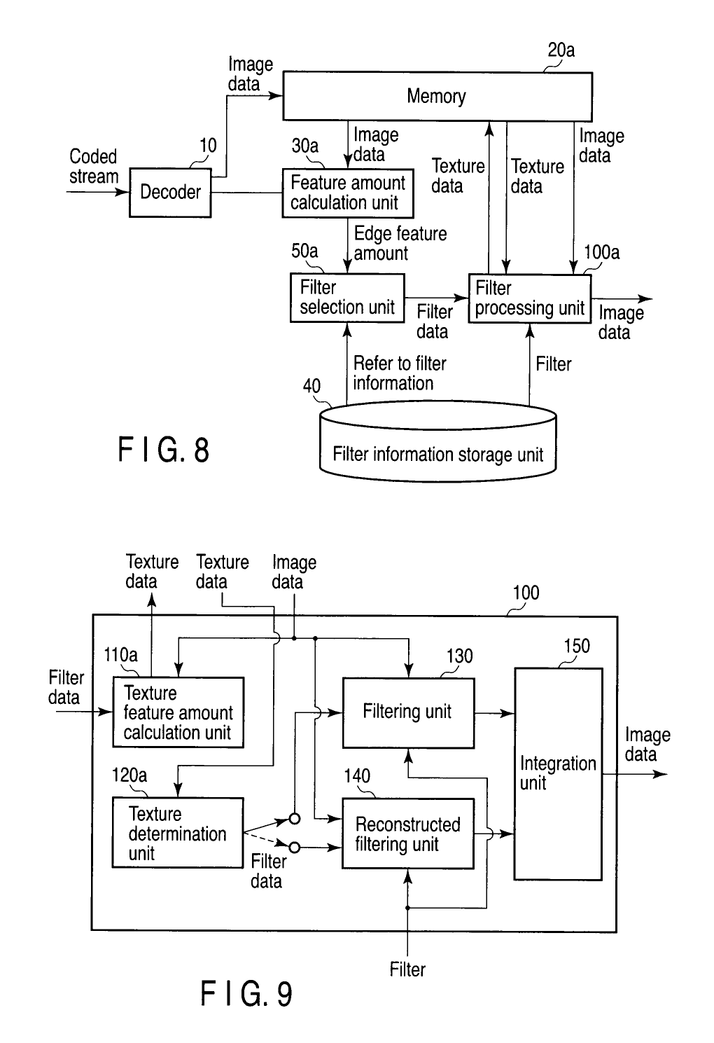

FIG. 8 shows the arrangement of an image processing apparatus according to Embodiment B3 of the present invention. The image processing apparatus comprises a decoder 10, memory 20a, feature amount calculation unit 30a, filter information storage unit 40, filter selection unit 50a, and filter processing unit 100a.

The decoder 10 receives a coded stream obtained by decoding the video signal of a moving image, and decodes the coded stream, thereby obtaining image data and encoding information of each frame. The encoding information includes quantization parameters, motion vectors, and picture information.

The memory 20a uses, for example, a semiconductor memory as a storage medium, and stores the image data output from the decoder 10 and texture data to be described later.

The feature amount calculation unit 30a reads out, from the memory 20a, the image data of a frame as the process target (to be referred to as a process target frame hereinafter). The feature amount calculation unit 30a divides one frame into blocks each having a predetermined size, and calculates the edge feature amount of the video for each block based on the image data. The edge feature amount obtained for each block is assigned a block index to identify the block, and output to the filter selection unit 50a. Note that the feature amount calculation unit 30a may obtain the edge feature amount of each block based on the encoding information obtained by the decoder 10.

The filter information storage unit 40 stores filter information in advance by associating templates of various edge feature amounts with filters. That is, a filter to be applied to an edge feature amount is associated with the template of the edge feature amount and stored as filter information in advance. Note that the filter is a set of filter coefficients to be applied to a filtering target pixel and its neighboring pixels.

The filter selection unit 50a refers to the filter information stored in the filter information storage unit 40, detects a filter corresponding to the edge feature amount of each block obtained by the feature amount calculation unit 30a, and outputs the index of the detected filter (to be referred to as a filter index hereinafter) associated with the block index assigned to the edge feature amount to the filter processing unit 100a as filter data.

Based on the image data and the filter data, the filter processing unit 100a performs filter processing of the image data for each block of the frame. For example, the filter processing unit 100a is configured as shown in FIG. 9, and comprises a texture feature amount calculation unit 110a, texture determination unit 120a, Filtering unit 130, Reconstructed filtering unit 140, and integration unit 150.

Upon receiving filter data from the filter selection unit 50a, the texture feature amount calculation unit 110a reads out, from the memory 20a, image data corresponding to the block index contained in the filter data, and calculates a texture feature amount representing the complexity of the image of the block based on the image data. The texture feature amount calculation unit 110a outputs the texture feature amount associated with the filter data to the texture determination unit 120a as texture data.

Upon receiving the texture data from the texture feature amount calculation unit 110a, the texture determination unit 120a determines, based on the texture feature amount contained in the texture data, the necessity of reconstruction of a filter based on the filter index contained in the texture data. If the texture feature amount does not exceed a threshold, i.e., if the video of the block of the process target block is monotonous, the filter data contained in the texture data is output to the Filtering unit 130. On the other hand, if the texture feature amount exceeds the threshold, i.e., if the video of the process target block is complex, the filter data is output to the Reconstructed filtering unit 140.

Upon receiving the filter data from the texture determination unit 120a, the Filtering unit 130 reads out, from the filter information storage unit 40, a filter corresponding to the filter index contained in the filter data. The Filtering unit 130 also reads out, from the memory 20a, image data corresponding to the block index contained in the filter data, and performs filter processing by applying the filter to the luminance value of each pixel of the block. The thus filtered image data of the block is output to the integration unit 150 together with the block index.

Upon receiving the filter data from the texture determination unit 120a, the Reconstructed filtering unit 140 reads out, from the filter information storage unit 40, a filter corresponding to the filter index contained in the filter data. The Reconstructed filtering unit 140 also reads out, from the memory 20a, image data corresponding to the block index contained in the filter data, reconstructs the readout filter using an ε filter for each pixel of the block based on the image data, and performs filter processing by applying each reconstructed filter to a corresponding pixel. The thus filtered image data of the block is output to the integration unit 150 together with the block index.

Upon obtaining image data that has undergone the filter processing for all blocks of the process target frame, the integration unit 150 integrates the image data filtered by the Filtering unit 130 and the Reconstructed filtering unit 140 into the image data of one frame based on the associated block indices, and outputs the image data.

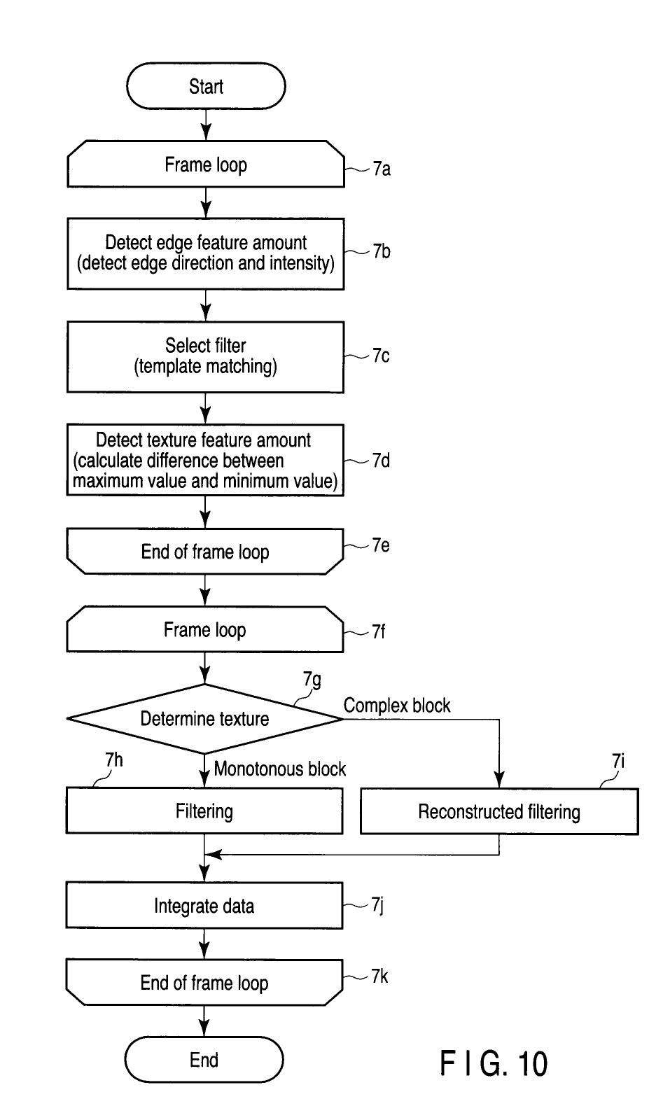

The operation of the image processing apparatus with the above arrangement will be described next. FIG. 10 is a flowchart for explaining the operation of the image processing apparatus. As shown in FIG. 10, the image processing apparatus executes frame loop control by repeating steps 7a to 7e for all blocks of one frame, and after the end of this control, executes processes in steps 7f to 7k.

In step 7a, the feature amount calculation unit 30a reads out the image data of the process target frame from the memory 20a, and the process advances to step 7b.

In step 7b, the feature amount calculation unit 30a applies a filter such as a Sobel filter, Prewitt filter, Robinson filter, or neighborhoods-difference filter to the readout image data, thereby calculating an edge feature amount representing the edge direction or intensity of each block of the one frame. The feature amount calculation unit 30a then assigns a block index to the edge feature amount obtained for each block, and outputs it to the filter selection unit 50a. The process advances to step 7c.

In step 7c, the filter selection unit 50a refers to the filter information stored in the filter information storage unit 40, performs template matching to detect a template which coincides with or is most similar to the edge feature amount of each block obtained by the feature amount calculation unit 30a, and reads out a filter index corresponding to the template. The filter selection unit 50a associates the readout filter index with the block index assigned to the edge feature amount used for template matching, and outputs them to the filter processing unit 100a as filter data. The process advances to step 7d.

In step 7d, the texture feature amount calculation unit 110a reads out, from the memory 20a, image data corresponding to the block index contained in the filter data received from the filter selection unit 50a. Based on the image data, the texture feature amount calculation unit 110a refers to the luminance value of each pixel of the block image, detects the maximum luminance value and the minimum luminance value, and detects the difference between them as a texture feature amount representing the complexity of the image. The texture feature amount calculation unit 110a records the texture feature amount associated with the filter data in the memory 20a as texture data. The process then advances to step 7e.

In step 7e, when the texture feature amount calculation unit 110a has confirmed that texture data has been generated for all blocks of the frame of the image read out in step 7a, the process advances to step 7f. If texture data has not been generated for all blocks, the process returns to step 7b to continue the processing for the remaining blocks.

In step 7f, the texture determination unit 120a reads out the texture data of the blocks of the process target frame from the memory 20a. The process advances to step 7g.

In step 7g, the texture determination unit 120a determines, based on the texture feature amount contained in the texture data read out in step 7f, whether it is necessary to reconstruct the filter of the filter index contained in each texture data.

More specifically, if the texture feature amount does not exceed a threshold, i.e., if the video of the block of the process target block is monotonous, the filter data is output to the Filtering unit 130, and the process advances to step 7h. On the other hand, if the texture feature amount exceeds the threshold, i.e., if the video of the process target block is complex, the filter data contained in the texture data is output to the Reconstructed filtering unit 140, and the process advances to step 7i.

In step 7h, the Filtering unit 130 reads out, from the filter information storage unit 40, a filter corresponding to the filter index contained in the filter data received from the texture determination unit 120a. The Filtering unit 130 also reads out, from the memory 20a, image data corresponding to the block index contained in the filter data, and performs filter processing by applying the filter to the luminance value of each pixel of the block.

More specifically, the Filtering unit 130 performs calculation represented by equation (3) described above.

The luminance values filtered in this way are integrated into image data of each block and output to the integration unit 150 together with the block index.

On the other hand, in step 7i, the Reconstructed filtering unit 140 reads out, from the filter information storage unit 40, a filter corresponding to the filter index contained in the filter data received from the texture determination unit 120a. The Reconstructed filtering unit 140 also reads out, from the memory 20a, image data corresponding to the block index contained in the filter data, reconstructs the filter to be applied using an ε filter for each pixel of the block based on the image data, and performs filtering.

More specifically, the Reconstructed filtering unit 140 performs calculation represented by equations (4) and (5) described above. That is, in the examples of equations, if a luminance value S(x,y) of the filtering target pixel is larger than a luminance value S(x−m,y−m) of a neighboring pixel (larger than a threshold Th), only the luminance value S(x,y) is used for filtering so as to perform the same filtering as that of a reconstructed filter. Otherwise, the same filtering as that of the Filtering unit 130 is performed.

The luminance values filtered in this way are integrated into image data of each block and output to the integration unit 150 together with the block index.

In step 7j, upon detecting that the image data of all blocks of the process target frame have been input from the Filtering unit 130 and the Reconstructed filtering unit 140, the integration unit 150 integrates these image data based on the associated block indices.

In step 7k, upon confirming that the image data of one frame has been completed by the integration in step 7j, the image data is output, and the process newly starts from step 7a for the next frame.

As described above, the image processing apparatus having the above-described arrangement does not apply the Reconstructed filtering unit 140 (ε filter) to the image data of all blocks. Instead, only when the texture feature amount exceeds the threshold, i.e., the video of the process target block is complex, the Reconstructed filtering unit 140 is applied.

Hence, according to the image processing apparatus with the above-described arrangement, since the Reconstructed filtering unit 140 is applied to only a complex block for which the filter is effective, it is possible to improve the video quality while suppressing the calculation amount.

Note that in the above embodiment, an example has been described in which the Reconstructed filtering unit 140 is an ε filter. However, the embodiment is also applicable when a bilateral filter is adopted. More specifically, when the Reconstructed filtering unit 140 is a bilateral filter, the Reconstructed filtering unit 140 performs the following processing in step 7i.

The Reconstructed filtering unit 140 reads out, from the filter information storage unit 40, a filter corresponding to the filter index contained in the filter data received from the texture determination unit 120a. The Reconstructed filtering unit 140 also reads out, from the memory 20a, image data corresponding to the block index contained in the filter data, reconstructs the filter to be applied using a bilateral filter for each pixel of the block based on the image data, and performs filtering.

More specifically, the Reconstructed filtering unit 140 performs calculation represented by equations (6) and (7) described above.

The luminance values filtered using the reconstructed filter in this way are integrated into image data of each block and output to the integration unit 150 together with the block index.

As described above, the embodiment is also applicable when the filter is reconstructed using a bilateral filter.

In the above-described embodiment, the texture feature amount calculation unit 110a obtains eth texture feature amount based on the luminance values of pixels of the image of the process target block, as described in step 7d. The texture feature amount may be obtained based on not the luminance values but color difference signals contained in the image data.

More specifically, in step 7d, the texture feature amount calculation unit 110a reads out, from the memory 20a, image data corresponding to the block index contained in the filter data received from the filter selection unit 50a. Based on the image data, the texture feature amount calculation unit 110a refers to the color difference signal of each pixel of the block image, detects the maximum color difference and the minimum color difference, and detects the difference between them as a texture feature amount representing the complexity of the image. The texture feature amount calculation unit 110a records the texture feature amount associated with the filter data in the memory 20a as texture data. The process then advances to step 7e.

That is, the same effect as described above can be obtained even by obtaining the texture feature amount based on the color difference signals.

The texture feature amount calculation unit 110a may obtain the texture feature amount based on both the luminance values and the color difference signals by the above-described method. In this case, the texture feature amount calculation unit 110a obtains a first texture feature amount based on luminance values and a second texture feature amount based on color difference signals, weights them, and calculates a texture feature amount by combining the first and second texture feature amounts. The texture determination unit 120a determines the complexity of the image based on the texture feature amount.

That is, obtaining the texture feature amount based on both luminance values and color difference signals allows to more accurately determine the complexity of the image.

In the above embodiment, the texture feature amount calculation unit 110a detects the texture feature amount based on only the image data of the process target block. Instead, the texture feature amount may be obtained based on, e.g., the image data of the process target block and the image data of a past frame (a frame temporally earlier than the process target frame) at the same block position as the process target block.

In this case, the texture feature amount calculation unit 110a obtains a first texture feature amount based on the image data of the process target block and a second texture feature amount based on the image data of a block corresponding to the process target block of a past frame, weights them, and calculates a texture feature amount by combining the first and second texture feature amounts. The texture determination unit 120a determines the complexity of the image based on the texture feature amount.

That is, obtaining the texture feature amount based on both current image data and past image data allows to more accurately determine the complexity of the image.

In addition, the memory 20a may store texture data for a plurality of past frames. The texture determination unit 120a compares the texture feature amount contained in the texture data of the process target block with the texture feature amount contained in the texture data of a block at the same position in the past.

If the difference exceeds a preset threshold, the process advances to step 7h. If the difference does not exceed the threshold, the process advances to step 7i to perform filtering.

### Embodiment B4

An image processing apparatus according to Embodiment B4 of the present invention will be described below. The arrangement of the image processing apparatus according to Embodiment B4 is apparently the same as that of the image processing apparatus according to Embodiment B3. As shown in FIG. 8, the image processing apparatus comprises a decoder 10, memory 20a, feature amount calculation unit 30a, filter information storage unit 40, filter selection unit 50a, and filter processing unit 100a.

The filter processing unit 100a of the image processing apparatus according to Embodiment B4 apparently has the same arrangement as that of the image processing apparatus according to Embodiment B3 except the process contents, and will be described with reference to FIG. 9.

More specifically, the filter processing unit 100a of the image processing apparatus according to Embodiment B4 comprises a texture feature amount calculation unit 110a, texture determination unit 120a, Filtering unit 130, Reconstructed filtering unit 140, and integration unit 150.

Upon receiving filter data from the filter selection unit 50a, the texture feature amount calculation unit 110a reads out, from the memory 20a, image data corresponding to the block index contained in the filter data, and calculates a texture feature amount representing the complexity of the image of the block based on the image data. The texture feature amount calculation unit 110a outputs the texture feature amount associated with the filter data to the texture determination unit 120a as texture data.

Upon receiving the texture data from the texture feature amount calculation unit 110a, the texture determination unit 120a determines, based on the texture feature amount contained in the texture data, the necessity of reconstruction of a filter based on the filter index contained in the texture data. If the texture feature amount does not exceed a threshold, i.e., if the video of the process target block is monotonous, the filter data contained in the texture data is output to the Filtering unit 130. On the other hand, if the texture feature amount exceeds the threshold, i.e., if the video of the process target block is complex, the filter data is output to the Reconstructed filtering unit 140.

Upon receiving the filter data from the texture determination unit 120a, the Filtering unit 130 reads out, from the filter information storage unit 40, a filter corresponding to the filter index contained in the filter data. The Filtering unit 130 also reads out, from the memory 20a, image data corresponding to the block index contained in the filter data, and performs filter processing by applying the filter to the luminance value of each pixel of the block. The thus filtered image data of the block is output to the integration unit 150 together with the block index.

Upon receiving the filter data from the texture determination unit 120a, the Reconstructed filtering unit 140 reads out, from the filter information storage unit 40, a filter corresponding to the filter index contained in the filter data. The Reconstructed filtering unit 140 also reads out, from the memory 20a, image data corresponding to the block index contained in the filter data, reconstructs the readout filter using an ε filter for each pixel of the block based on the image data, and performs filter processing by applying each reconstructed filter to a corresponding pixel. The thus filtered image data of the block is output to the integration unit 150 together with the block index.

Upon obtaining image data that has undergone the filter processing for all blocks of the process target frame, the integration unit 150 integrates the image data filtered by the Filtering unit 130 and the Reconstructed filtering unit 140 into the image data of one frame based on the associated block indices, and outputs the image data.

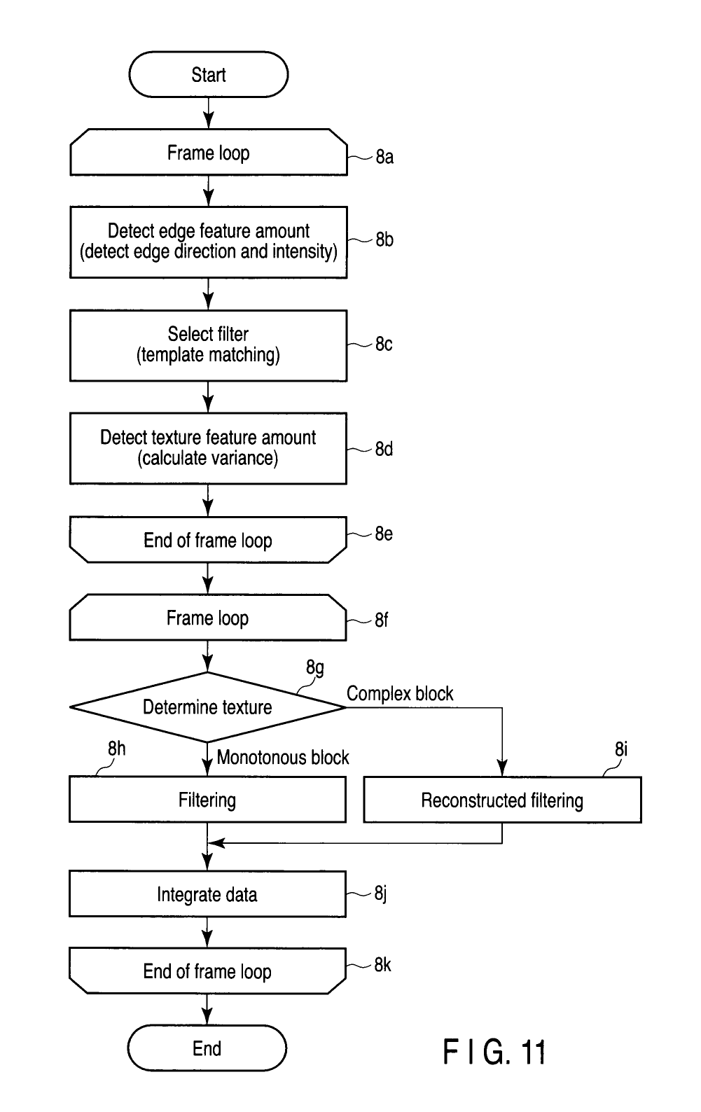

The operation of the image processing apparatus with the above arrangement will be described next. FIG. 11 is a flowchart for explaining the operation of the image processing apparatus. As shown in FIG. 11, the image processing apparatus executes frame loop control by repeating steps 8a to 8e for all blocks of one frame, and after the end of this control, executes processes in steps 8f to 8k.

In step 8a, the feature amount calculation unit 30a reads out the image data of the process target frame from the memory 20a, and the process advances to step 8b.

In step 8b, the feature amount calculation unit 30a applies a filter such as a Sobel filter, Prewitt filter, Robinson filter, or neighborhoods-difference filter to the readout image data, thereby calculating an edge feature amount representing the edge direction or intensity of each block of the one frame. The feature amount calculation unit 30a then assigns a block index to the edge feature amount obtained for each block, and outputs it to the filter selection unit 50a. The process advances to step 8c.

In step 8c, the filter selection unit 50a refers to the filter information stored in the filter information storage unit 40, performs template matching to detect a template which coincides with or is most similar to the edge feature amount of each block obtained by the feature amount calculation unit 30a, and reads out a filter index corresponding to the template. The filter selection unit 50a associates the readout filter index with the block index assigned to the edge feature amount used for template matching, and outputs them to the filter processing unit 100a as filter data. The process advances to step 8d.

In step 8d, the texture feature amount calculation unit 110a reads out, from the memory 20a, image data corresponding to the block index contained in the filter data received from the filter selection unit 50a. Based on the image data, the texture feature amount calculation unit 110a refers to the luminance value of each pixel of the block image, calculates the variance of the luminance values, and detects the value as a texture feature amount representing the complexity of the image. The texture feature amount calculation unit 110a records the texture feature amount associated with the filter data in the memory 20a as texture data. The process then advances to step 8e.

In step 8e, when the texture feature amount calculation unit 110a has confirmed that texture data has been generated for all blocks of the frame of the image read out in step 8a, the process advances to step 8f. If texture data has not been generated for all blocks, the process returns to step 8b to continue the processing for the remaining blocks.

In step 8f, the texture determination unit 120a reads out the texture data of the blocks of the process target frame from the memory 20a. The process advances to step 8g.

In step 8g, the texture determination unit 120a determines, based on the texture feature amount contained in the texture data read out in step 8f, whether it is necessary to reconstruct the filter of the filter index contained in each texture data.

More specifically, if the texture feature amount does not exceed a threshold, i.e., if the video of the block of the process target block is monotonous, the filter data is output to the Filtering unit 130, and the process advances to step 8h. On the other hand, if the texture feature amount exceeds the threshold, i.e., if the video of the process target block is complex, the filter data contained in the texture data is output to the Reconstructed filtering unit 140, and the process advances to step 8i.

In step 8h, the Filtering unit 130 reads out, from the filter information storage unit 40, a filter corresponding to the filter index contained in the filter data received from the texture determination unit 120a. The Filtering unit 130 also reads out, from the memory 20a, image data corresponding to the block index contained in the filter data, and performs filter processing by applying the filter to the luminance value of each pixel of the block.

More specifically, the Filtering unit 130 performs calculation represented by equation (3) described above.

The luminance values filtered in this way are integrated into image data of each block and output to the integration unit 150 together with the block index.

On the other hand, in step 8i, the Reconstructed filtering unit 140 reads out, from the filter information storage unit 40, a filter corresponding to the filter index contained in the filter data received from the texture determination unit 120a. The Reconstructed filtering unit 140 also reads out, from the memory 20a, image data corresponding to the block index contained in the filter data, reconstructs the filter to be applied using an ε filter for each pixel of the block based on the image data, and performs filtering.

More specifically, the Reconstructed filtering unit 140 performs calculation represented by equations (4) and (5) described above. That is, in the examples of equations, if a luminance value S(x,y) of the filtering target pixel is larger than a luminance value S(x−m,y−m) of a neighboring pixel (larger than a threshold Th), only the luminance value S(x,y) is used for filtering so as to perform the same filtering as that of a reconstructed filter. Otherwise, the same filtering as that of the Filtering unit 130 is performed.

The luminance values filtered in this way are integrated into image data of each block and output to the integration unit 150 together with the block index.

In step 8j, upon detecting that the image data of all blocks of the process target frame have been input from the Filtering unit 130 and the Reconstructed filtering unit 140, the integration unit 150 integrates these image data based on the associated block indices.

In step 8k, upon confirming that the image data of one frame has been completed by the integration in step 8j, the image data is output, and the process newly starts from step 8a for the next frame.

As described above, the image processing apparatus having the above-described arrangement does not apply the Reconstructed filtering unit 140 (ε filter) to the image data of all blocks. Instead, only when the texture feature amount exceeds the threshold, i.e., the video of the process target block is complex, the Reconstructed filtering unit 140 is applied.

Hence, according to the image processing apparatus with the above-described arrangement, since the Reconstructed filtering unit 140 is applied to only a complex block for which the filter is effective, it is possible to improve the video quality while suppressing the calculation amount.

Note that in the above embodiment, an example has been described in which the Reconstructed filtering unit 140 is an ε filter. However, the embodiment is also applicable when a bilateral filter is adopted. More specifically, when the Reconstructed filtering unit 140 is a bilateral filter, the Reconstructed filtering unit 140 performs the following processing in step 8i.

The Reconstructed filtering unit 140 reads out, from the filter information storage unit 40, a filter corresponding to the filter index contained in the filter data received from the texture determination unit 120a. The Reconstructed filtering unit 140 also reads out, from the memory 20a, image data corresponding to the block index contained in the filter data, reconstructs the filter to be applied using a bilateral filter for each pixel of the block based on the image data, and performs filtering.

More specifically, the Reconstructed filtering unit 140 performs calculation represented by equations (6) and (7) described above.

The luminance values filtered using the reconstructed filter in this way are integrated into image data of each block and output to the integration unit 150 together with the block index.

As described above, the embodiment is also applicable when the filter is reconstructed using a bilateral filter.

In the above-described embodiment, the texture feature amount calculation unit 110a obtains eth texture feature amount based on the luminance values of pixels of the image of the process target block, as described in step 8d. The texture feature amount may be obtained based on not the luminance values but color difference signals contained in the image data.

More specifically, in step 8d, the texture feature amount calculation unit 110a reads out, from the memory 20a, image data corresponding to the block index contained in the filter data received from the filter selection unit 50a. Based on the image data, the texture feature amount calculation unit 110a refers to the color difference signal of each pixel of the block image, calculates the variance of the color difference signals, and detects the value as a texture feature amount representing the complexity of the image. The texture feature amount calculation unit 110a records the texture feature amount associated with the filter data in the memory 20a as texture data. The process then advances to step 8e.

That is, the same effect as described above can be obtained even by obtaining the texture feature amount based on the color difference signals.

The texture feature amount calculation unit 110a may obtain the texture feature amount based on both the luminance values and the color difference signals by the above-described method. In this case, the texture feature amount calculation unit 110a obtains a first texture feature amount based on luminance values and a second texture feature amount based on color difference signals, weights them, and calculates a texture feature amount by combining the first and second texture feature amounts. The texture determination unit 120a determines the complexity of the image based on the texture feature amount.

That is, obtaining the texture feature amount based on both luminance values and color difference signals allows to more accurately determine the complexity of the image.

In the above embodiment, the texture feature amount calculation unit 110a detects the texture feature amount based on only the image data of the process target block. Instead, the texture feature amount may be obtained based on, e.g., the image data of the process target block and the image data of a past frame (a frame temporally earlier than the process target frame) at the same block position as the process target block.

In this case, the texture feature amount calculation unit 110a obtains a first texture feature amount based on the image data of the process target block and a second texture feature amount based on the image data of a block corresponding to the process target block of a past frame, weights them, and calculates a texture feature amount by combining the first and second texture feature amounts. The texture determination unit 120a determines the complexity of the image based on the texture feature amount.

That is, obtaining the texture feature amount based on both current image data and past image data allows to more accurately determine the complexity of the image.

In addition, the memory 20a may store texture data for a plurality of past frames. The texture determination unit 120a compares the texture feature amount contained in the texture data of the process target block with the texture feature amount contained in the texture data of a block at the same position in the past.

If the difference exceeds a preset threshold, the process advances to step 8h. If the difference does not exceed the threshold, the process advances to step 8i to perform filtering.

Note that the present invention is not exactly limited to the above embodiments, and constituent elements can be modified in the stage of practice without departing from the spirit and scope of the invention. Various inventions can be formed by properly combining a plurality of constituent elements disclosed in the above embodiments. For example, several constituent elements may be omitted from all the constituent elements described in the embodiments. In addition, constituent elements throughout different embodiments may be properly combined.

For example, in the above-described embodiments, based on the edge feature amount obtained by the feature amount calculation unit 30, the filter selection unit 50 selects a filter to be applied. However, the embodiments are also applicable to, e.g., an image processing apparatus assumed to apply a predetermined filter independently of the edge feature amount. That is, the same effect can be obtained by applying the embodiments to an image processing apparatus whose Filtering unit 130 uses a preset filter.

In the above-described embodiments, the texture feature amount calculation unit 110 (or texture feature amount calculation unit 110a) obtains the texture feature amount based on the information (luminance values or/and color difference signals) of pixels included in a block to be referred by the filter. However, the present invention is not limited to this. The texture feature amount may be obtained based on the information (luminance values or/and color difference signals) of pixels in a predetermined range larger or smaller than a block.

In the above-described embodiments, the filter to be applied is switched for each block. However, the present invention is not limited to this. The filter to be applied may be switched for a predetermined range larger or smaller than a block.

More specifically, assume that a frame includes S×T pixels, the texture feature amount calculation is done for I×J pixels, and the filter tap includes M×N pixels. In this case, the embodiments can be implemented by setting the values S, T, I, J, M, and N to arbitrary integers of 1 or more. As described above, the sizes are not limited to those exemplified in the embodiments.

For example, the texture feature amount is obtained based on the maximum/minimum values or variance of the luminance values or color difference signals of the pixels. However, both the maximum/minimum values and variance may be used.

For example, the texture feature amount calculation unit 110 (or texture feature amount calculation unit 110a) obtains a first texture feature amount based on the difference between the maximum value and the minimum value of luminance values and a second texture feature amount based on the variance of luminance values, weights them, and calculates a texture feature amount by combining the first and second texture feature amounts. The texture determination unit 120 (or texture determination unit 120a) determines the complexity of the image based on the texture feature amount.

Alternatively, the texture feature amount calculation unit 110 (or texture feature amount calculation unit 110a) obtains a first texture feature amount based on the difference between the maximum value and the minimum value of color difference signals and a second texture feature amount based on the variance of color difference signals, weights them, and calculates a texture feature amount by combining the first and second texture feature amounts. The texture determination unit 120 (or texture determination unit 120a) determines the complexity of the image based on the texture feature amount.

Otherwise, the texture feature amount calculation unit 110 (or texture feature amount calculation unit 110a) obtains a first texture feature amount based on the difference between the maximum value and the minimum value of luminance values and a second texture feature amount based on the variance of color difference signals, weights them, and calculates a texture feature amount by combining the first and second texture feature amounts. The texture determination unit 120 (or texture determination unit 120a) determines the complexity of the image based on the texture feature amount.

Instead, the texture feature amount calculation unit 110 (or texture feature amount calculation unit 110a) obtains a first texture feature amount based on the difference between the maximum value and the minimum value of color difference signals and a second texture feature amount based on the variance of luminance values, weights them, and calculates a texture feature amount by combining the first and second texture feature amounts. The texture determination unit 120 (or texture determination unit 120a) determines the complexity of the image based on the texture feature amount.

Obtaining the texture feature amount based on two different kinds of evaluations of one kind of information or two different kinds of evaluations of two kinds of information allows to more accurately determine the complexity of the image.

### Embodiment C1

An embodiment of the present invention will be described below with reference to the accompanying drawing.

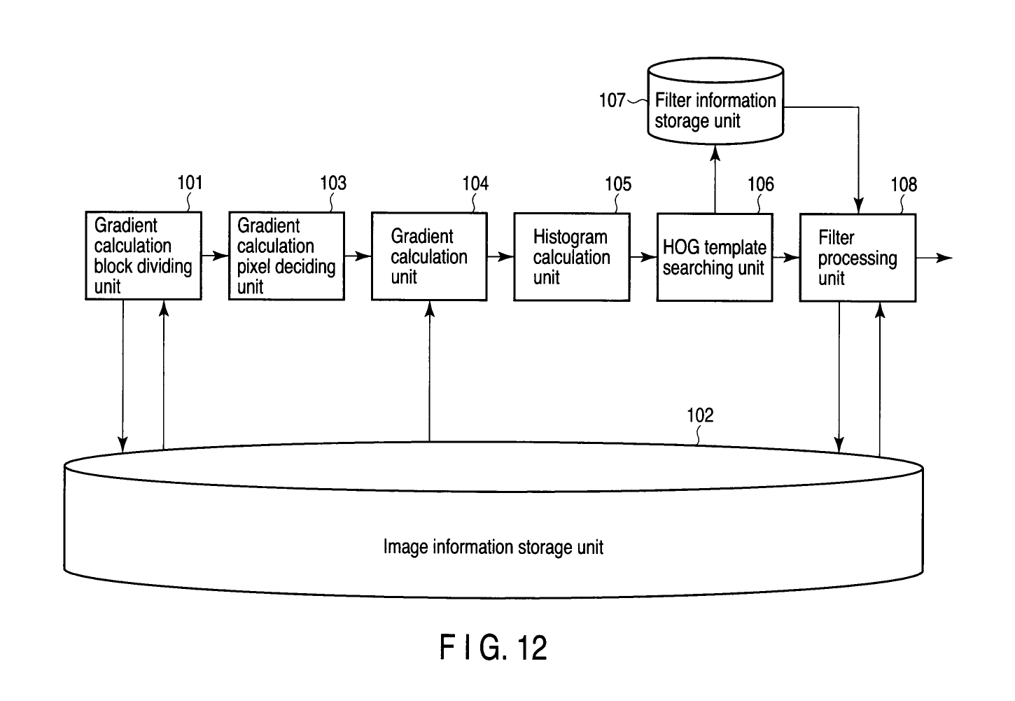

As shown in FIG. 12, an image processing apparatus according to Embodiment C1 of the present invention comprises a gradient calculation block dividing unit 101, image information storage unit 102, gradient calculation pixel deciding unit 103, gradient calculation unit 104, histogram calculation unit 105, HOG template searching unit 106, filter information storage unit 107, and filter processing unit 108.

The gradient calculation block dividing unit 101 divides an image signal of a predetermined unit stored in the image information storage unit 102 into block image signals (to be simply referred to as gradient calculation blocks hereinafter). The image information storage unit 102 stores, for example, a decoded image signal obtained by causing an image decoding means (not shown) to decode an image signal encoded by an image encoding means (e.g., an encoder supporting MPEG-2, MPEG-4, H.264, or the like). A gradient calculation block can have arbitrary size and shape. For the descriptive convenience, a gradient calculation block is assumed to be a rectangle of N×N (N is an arbitrary fixed value) pixels. The gradient calculation block dividing unit 101 inputs a gradient calculation block to the gradient calculation pixel deciding unit 103.

The gradient calculation pixel deciding unit 103 decides one of the pixels included in the gradient calculation block as a gradient calculation pixel. The gradient calculation pixel deciding unit 103 can decide an arbitrary pixel as the gradient calculation pixel. For example, the gradient calculation pixel deciding unit 103 decides, as the gradient calculation pixel, a pixel corresponding to a specific relative position of each gradient calculation block (for example, the central position of each gradient calculation block). The gradient calculation pixel deciding unit 103 inputs the gradient calculation pixel to the gradient calculation unit 104.

The gradient calculation unit 104 calculates the directions and magnitudes (angles and intensities) of the gradients (luminance gradients) of the gradient calculation pixel and neighboring pixels (e.g., adjacent pixels). The gradient calculation unit 104 calculates gradient magnitudes θx(x,y) and θy(x,y) in the x direction (also referred to as the horizontal direction or lateral direction) and y direction (also referred to as the vertical direction or longitudinal direction) of a pixel corresponding to coordinates (x,y) by, e.g.,

∂x(x,y)=In(x+i, y)−In(x, y)

∂y(x,y)=In(x, y+i)−In(x, y) (8)

where In(x,y) is the luminance value of the pixel corresponding to the coordinates (x,y), and i is a parameter (forward amount) for gradient calculation and typically uses “1”. Note that the gradient calculation unit 104 may use a Sobel operator or the like in place of the forward difference scheme represented by equations (8).

In place of equations (8), the gradient may be calculated for the pixel of characteristic (the pixel corresponding to the coordinate (x,y)) using

∂x(x,y)=In(i+i,y)−In(x−i,y)

∂y(x,y)=In(x,y+i)−In(x,y−i) (9)

The gradient calculation unit 104 calculates an intensity d(x,y) and angle θ(x,y) of the gradient of the pixel corresponding to the coordinates (x,y) by, e.g.,

$$d ( x , y ) = \sqrt{\partial {x ( x , y )}^{2} + \partial {y ( x , y )}^{2}} \\ θ ( x , y ) = {tan}^{- 1} ( \frac{\partial y ( x , y )}{\partial x ( x , y )} ) \qquad ( 10 )$$

The gradient calculation unit 104 inputs, to the histogram calculation unit 105, the gradient intensities d and angles θ of the gradient calculation pixel and neighboring pixels.

The histogram calculation unit 105 calculates histograms using the intensities d and angles θ of the gradients of the gradient calculation pixel and neighboring pixels. More specifically, the histogram calculation unit 105 samples the gradient angles θ in a plurality of directions, and totalizes the gradient intensities d belonging to each directions, thereby calculating histograms HOG (Histograms of Oriented Gradients). In the following example, the histogram calculation unit 105 samples (quantizes) the gradient angles θ in K directions (K is an arbitrary natural number), and totalizes the gradient intensities d belonging to each sampling direction so as to calculate histograms h[k] (k=0, 1, . . . , K-1). First, the histogram calculation unit 105 initializes each histogram h[k] (substitutes “0”) by

h[k]=0 (11)

Next, the histogram calculation unit 105 samples the gradient angles θ of the gradient calculation pixel and neighboring pixels in the K directions by

$$φ ( x , y ) = round ( \frac{θ ( x , y )}{2 π / K} ) \qquad ( 12 )$$

where round( )is the round-off function. The histogram calculation unit 105 totalizes the gradient intensities d belonging to each sampling direction φ (φ=0, 1, . . . , K-1) to calculate the histogram h[k] by

h[φ(x+i,y+j)]=h[φ(x+i,y+j)]+d(x+i,y+j) (13)

where i and j are x- and y-direction shift amounts for designating the neighboring pixels around the gradient calculation pixel corresponding to the coordinates (x,y). More specifically, when the histogram totalization region (i.e., gradient calculation region) is assumed to be a square region centered on the coordinates (x,y) and having a side length of 2r+1, −r≦i, and j≦r. For example, for a square region centered on the coordinates (x,y) and having a side length of 3, −1≦i, and j≦1.

The histogram calculation unit 105 inputs the HOGs (e.g., h[0], h[1], . . . , h[K-1]) to the HOG template searching unit 106.

The filter information storage unit 107 stores a plurality of HOG templates and a plurality of kinds of filter information (especially filter coefficients) in association with each other. Preferably, optimum filter information derived by, e.g., learning using sample images is associated with each HOG template. An arbitrary learning method is applicable, and a detailed description of the filter information learning method will be omitted.

The HOG template searching unit 106 searches the plurality of HOG templates stored in the filter information storage unit 107 for a template most similar to the HOG calculated by the histogram calculation unit 105. The similarity can be evaluated by an arbitrary index such as SAD (Sum of Absolute Difference) or SSD (Sum of Square Difference). The HOG template searching unit 106 inputs the identifier of the found HOG template to the filter processing unit 108.

Using the identifier of the HOG template, the filter processing unit 108 reads out corresponding filter information from the filter information storage unit 107. The filter processing unit 108 performs filter processing of each pixel of the gradient calculation block using the filter information. Filter processing is a convolution operation expressed by, e.g.,

$$Out ( x , y ) = {\sum }_{- R \leq m \leq R , - R \leq n \leq R} w ( m , n ) \cdot In ( x + m , y + n ) \qquad ( 14 )$$

where Out(x,y) is the pixel value of the pixel corresponding to the coordinates (x,y) after filter processing, R is a parameter representing the tap length of the filter, and w(m,n) is a filter coefficient corresponding to relative coordinates (m,n) with respect to the filter center (0,0).

The filter processing unit 108 stores the pixel after the filter processing in the image information storage unit 102, thereby generating a corrected image signal. The filter processing unit 108 receives the reference address to the corrected image signal from the image information storage unit 102, and inputs the image to an output device (for example, a display device such as an LCD display or organic EL display) (not shown).

Note that the filter processing unit 108 may perform ε filter processing. In ε filter processing, the luminance value of an adjacent pixel whose difference from the luminance value at the filter center is equal to or larger than a threshold THeps replaces the luminance value at the filter center. Then, the convolution operation of equation (14) is applied. Applying the ε filter processing enables smoothing while discriminating between edge pixels and non-edge pixels. For this reason, degradation of subjective image quality can be suppressed.

More specifically, the ε filter processing is represented by

$$Out ( x , y ) = {\sum }_{- R \leq m \leq R , - R \leq n \leq R} w ( m , n ) \cdot p ( x + m , y + n ) \\ \{ \begin{matrix}p ( x + m , y + n ) = In ( x , y ) & if . \vert In ( x + m , y + n ) - In ( x , y ) \vert \geq {TH}_{eps} \\ p ( x + m , y + n ) = In ( x + m , y + n ) & Else .\end{matrix} \qquad ( 15 )$$

where the threshold THeps is a preset constant that is an experimentally decided value.

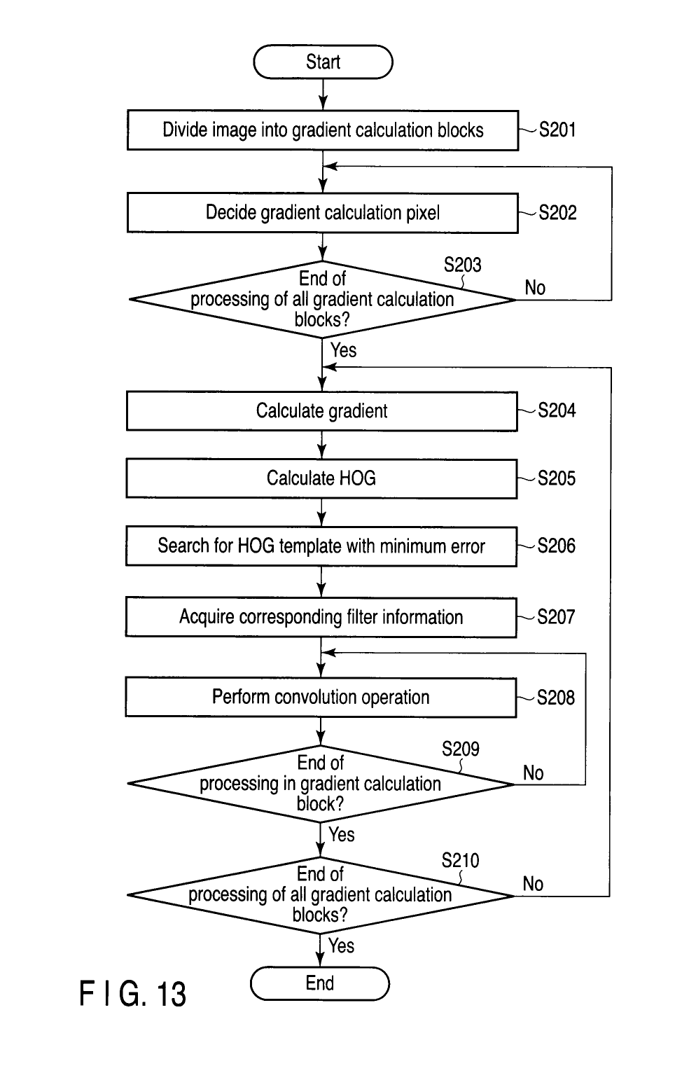

Processing executed by the image processing apparatus shown in FIG. 12 will be described below with reference to FIG. 13.

First, the gradient calculation block dividing unit 101 divides an image signal stored in the image information storage unit 102 into gradient calculation blocks (step S201). The process advances to step S202.

In step S202, the gradient calculation pixel deciding unit 103 decides the gradient calculation pixel in a process target gradient calculation block (step S202). If the process in step S202 has ended for all gradient calculation blocks, the process advances to step S204. Otherwise, the process returns to step S202 to perform processing of the next gradient calculation block (step S203).

In step S204, the gradient calculation unit 104 calculates the gradient intensities and gradient angles of the gradient calculation pixel and neighboring pixels of the process target gradient calculation block. Then, the histogram calculation unit 105 quantizes the gradient angles calculated in step S204 and totalizes the gradient intensities for each sampled angle to calculate the HOG (step S205). The HOG template searching unit 106 searches the filter information storage unit 107 for a HOG template that is most similar (has a minimum error) to the HOG calculated in step S205 (step S206). The filter processing unit 108 acquires, from the filter information storage unit 107, filter information corresponding to the HOG template found in step S207 (step S207). The process advances to step S208.

In step S208, the filter processing unit 108 performs filter processing (convolution operation) for a process target pixel in the gradient calculation block using the filter information acquired in step S207. If the process in step S208 has ended for all pixels in the process target gradient calculation block, the process advances to step S210. Otherwise, the process returns to step S208 to perform processing of the next pixel (step S209).

The filter information found based on the HOG of the gradient calculation pixel is also used for pixels other than the gradient calculation pixel in the gradient calculation block. Generally, since an image signal is nonsteady, the characteristic of the picture represented by the HOG of the pixel has high correlation around neighboring pixel. The image processing apparatus of this embodiment uses the HOG of the gradient calculation pixel to the neighboring pixels, thereby simplifying calculation necessary for HOG calculation and filter information acquisition.

If the processes in steps S204 to S209 have ended for all gradient calculation blocks, the processing ends. Otherwise, the process returns to step S204 to perform processing of the next gradient calculation block.

As described above, the image processing apparatus according to this embodiment divides an image signal into gradient calculation blocks, decides one pixel in each gradient calculation block as a representative pixel (gradient calculation pixel), and selects filter information to be applied to the constituent pixels of each gradient calculation block based on the HOGs of the representative pixel and neighboring pixels. Hence, according to the image processing apparatus of the embodiment, it is possible to efficiently select appropriate filter information for each gradient calculation block.

### Embodiment C2

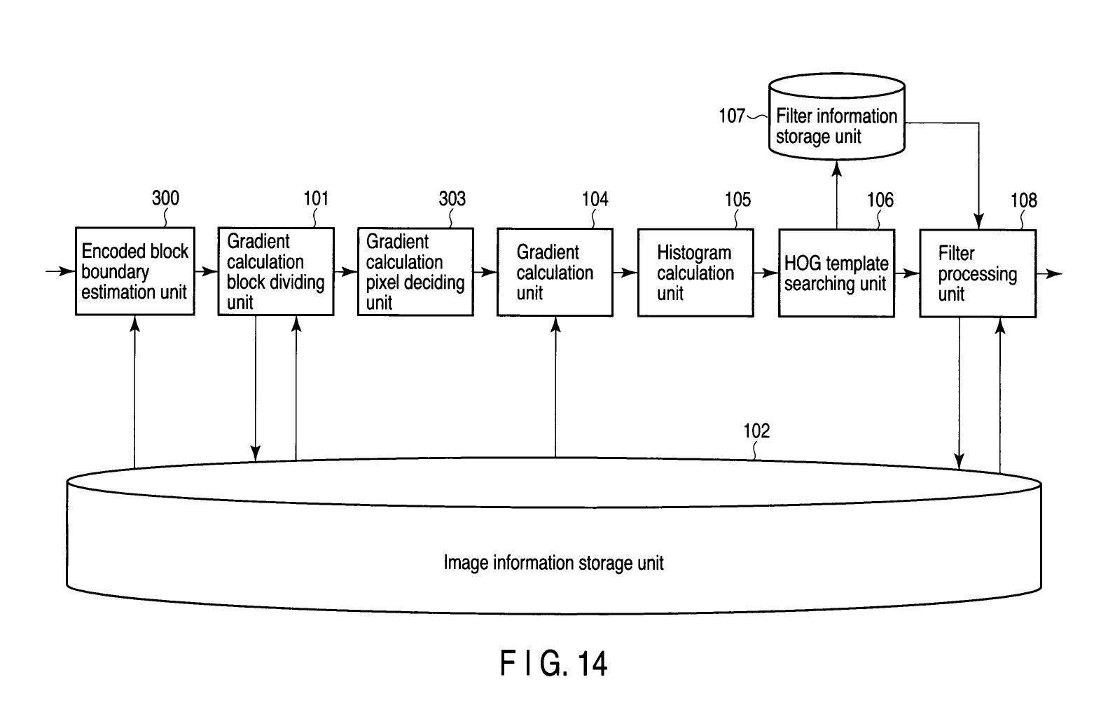

As shown in FIG. 14, an image processing apparatus according to Embodiment C2 of the present invention is formed by adding an encoded block boundary estimation unit 300 and replacing the gradient calculation pixel deciding unit 103 with a gradient calculation pixel deciding unit 303 in the image processing apparatus in FIG. 12. The same reference numerals as in FIG. 12 denote the same parts in FIG. 14, and different parts will mainly be explained below.

The encoded block boundary estimation unit 300 estimates the encoded block boundaries of an image signal (decoded image signal) stored in an image information storage unit 102. For example, an image decoding means (not shown) inputs, to the encoded block boundary estimation unit 300, the encoding information of an image signal stored in the image information storage unit 102. Upon detecting based on the encoding information that the image signal had been encoded by H.264, the encoded block boundary estimation unit 300 regards a 4×4 rectangular block as an encoded block, and estimates the boundary between adjacent encoded blocks as an encoded block boundary. Alternatively, upon detecting based on the encoding information that the image signal had been encoded by MPEG-2, MPEG-4, or JPEG, the encoded block boundary estimation unit 300 regards an 8×8 rectangular block as an encoded block, and estimates the boundary between adjacent encoded blocks as an encoded block boundary. The encoded block boundary estimation unit 300 notifies a gradient calculation block dividing unit 101 of the estimated encoded block boundaries.

The gradient calculation block dividing unit 101 divides the image signal stored in the image information storage unit 102 into gradient calculation blocks, as in Embodiment C1 described above. Each gradient calculation block preferably has a size equal to or smaller than the above-described encoded block. In the following description, the encoded block is an M×M rectangular block, and the gradient calculation block is an N×N (N≦M) rectangular block, unless it is specifically stated otherwise.

If the size N of the gradient calculation block is an odd number, the gradient calculation pixel deciding unit 303 decides the central pixel of the gradient calculation block as the gradient calculation pixel. More exactly, if the gradient calculation block is a rectangular block having an odd number of pixels in both the horizontal and vertical directions, the gradient calculation pixel deciding unit 303 can decide the gradient calculation pixel by the same method.

If the size N of the gradient calculation block is an even number, the gradient calculation pixel deciding unit 303 extracts a plurality of pixels adjacent to the central coordinates of the gradient calculation block as candidate pixels. Next, the gradient calculation pixel deciding unit 303 searches the intersections of the encoded block boundaries estimated by the block boundary estimation unit 300 for an intersection closest to the gradient calculation block (for example, an intersection having a minimum Euclidean distance or Manhattan distance). The gradient calculation pixel deciding unit 303 decides, as the gradient calculation pixel, a candidate pixel farthest from the found intersection of the block boundaries (for example, a pixel having a maximum Euclidean distance or Manhattan distance). More exactly, if the gradient calculation block is a rectangular block having an even number of pixels in at least one of the horizontal and vertical directions, the gradient calculation pixel deciding unit 303 can decide the gradient calculation pixel by the same method.

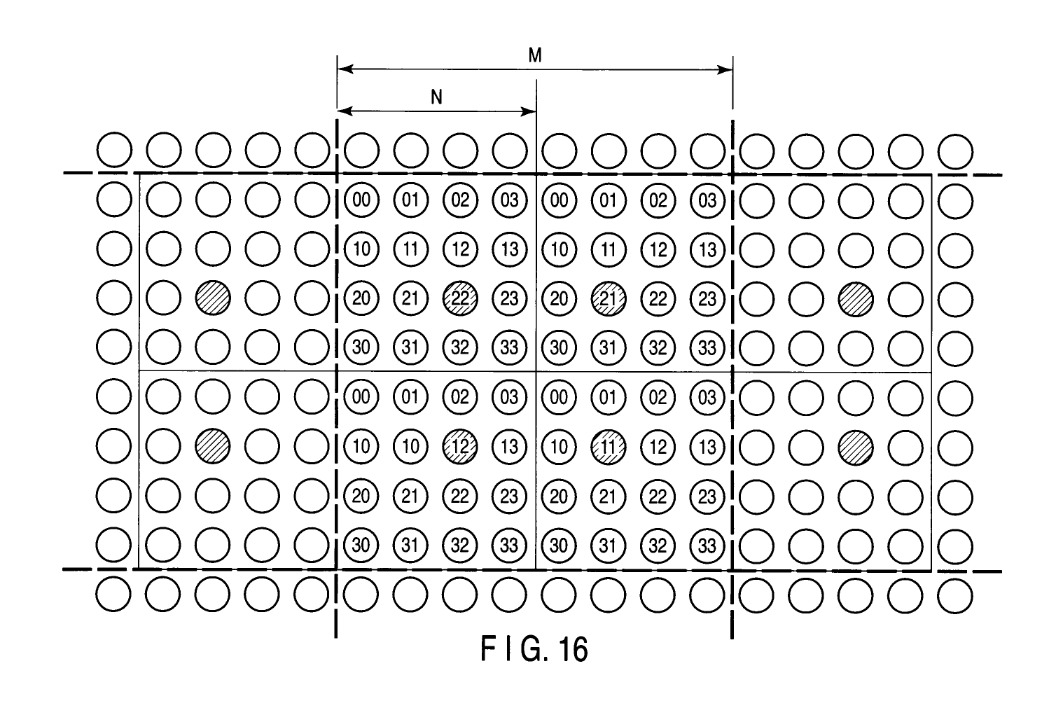

The technical meaning of deciding the gradient calculation pixel considering the block boundaries will be described below with reference to FIG. 16. Note that N=M/2 in FIG. 16. Encoded block boundaries are indicated by broken lines, gradient calculation block boundaries are indicated by solid lines, and pixels are indicated by circles in FIG. 16.

As is generally known, when an image signal is encoded and decoded for each block, distortion (block distortion) occurs between the blocks. That is, a gradient calculated across a block boundary in a decoded image signal may be alienated from the original gradient in the original image signal. Hence, calculating a gradient across a block boundary may lead to selection of inappropriate filter information, and is not preferable for the image processing apparatus according to this embodiment. Preferably, a pixel (hatched pixel) relatively far from the encoded block boundary is decided as the gradient calculation pixel in each gradient calculation block, as shown in FIG. 16, to prevent block distortion upon gradient calculation from mixing.

For example, referring to FIG. 16, each gradient calculation block is a 4×4 rectangular block. Hence, the gradient calculation pixel deciding unit 303 extracts four pixels (pixels numbered “11”, “12”, “21”, and “22” in each gradient calculation block) adjacent to the central pixel as candidate pixels. In each gradient calculation block, the gradient calculation pixel deciding unit 303 decides, as the gradient calculation pixel, a candidate pixel (hatched pixel) farthest from the encoded block boundary.

Note that as is apparent from FIG. 16, when gradient calculation blocks are set by dividing an encoded block into equal parts (in this example, when a divisor of M is set as N), the candidate pixels to be decided as the gradient calculation pixel can systematically be decided in accordance with the relative positions of the gradient calculation blocks in the encoded block. For example, in a gradient calculation block located at the upper left portion of the encoded block, the lower right candidate pixel can systematically be decided as the gradient calculation pixel. Hence, setting gradient calculation blocks by dividing an encoded block into equal parts is preferable from the viewpoint of processing amount reduction.

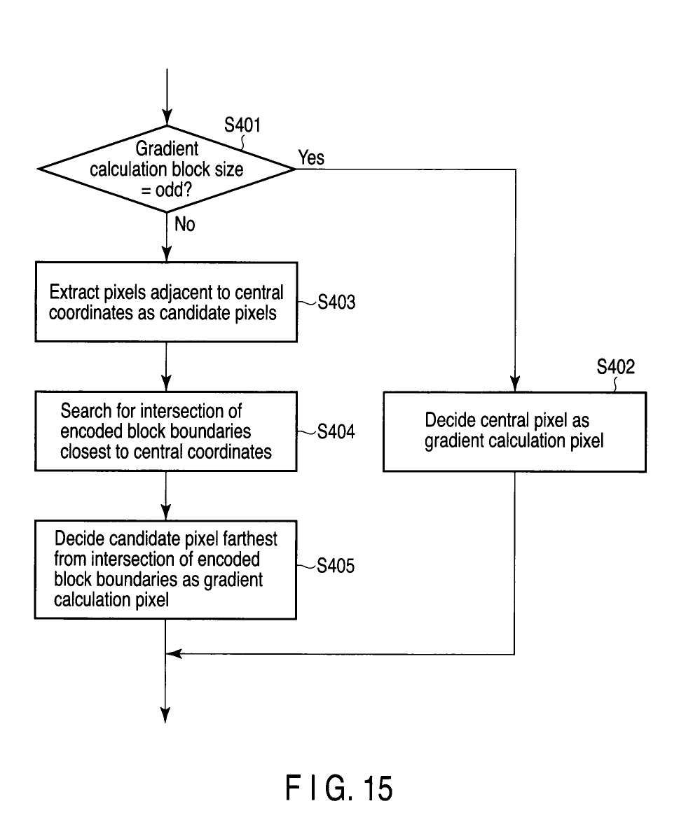

Note that the processing of the image processing apparatus shown in FIG. 14 is implemented by replacing the process of step S202 in FIG. 13 with processing shown in FIG. 15. Processing executed by the gradient calculation pixel deciding unit 303 in FIG. 14 will be described below with reference to FIG. 15.

First, the gradient calculation pixel deciding unit 303 determines whether the size of the gradient calculation block is an odd number (step S401). If the size of the gradient calculation block is an odd number, the process advances to step S402. Otherwise, the process advances to step S403.

In step S402, the gradient calculation pixel deciding unit 303 decides the central pixel of the gradient calculation block as the gradient calculation pixel, and the processing in FIG. 15 ends. On the other hand, in step S403, the gradient calculation pixel deciding unit 303 extracts a plurality of pixels adjacent to the central coordinates of the gradient calculation block as candidate pixels. Next, the gradient calculation pixel deciding unit 303 searches for an intersection of the encoded block boundaries closest to the central coordinates of the gradient calculation block (step S404). The gradient calculation pixel deciding unit 303 decides, as the gradient calculation pixel, a candidate pixel farthest from the encoded block boundary intersection found in step S404, and the processing in FIG. 15 ends.

As described above, the image processing apparatus according to this embodiment decides, as the gradient calculation pixel, the central pixel of a gradient calculation block or one of pixels adjacent to the central coordinates which is farthest from the block boundary. Hence, according to the image processing apparatus of the embodiment, since block distortion upon gradient calculation can be prevented from mixing, it is possible to select appropriate filter information for each gradient calculation block.

### Embodiment C3

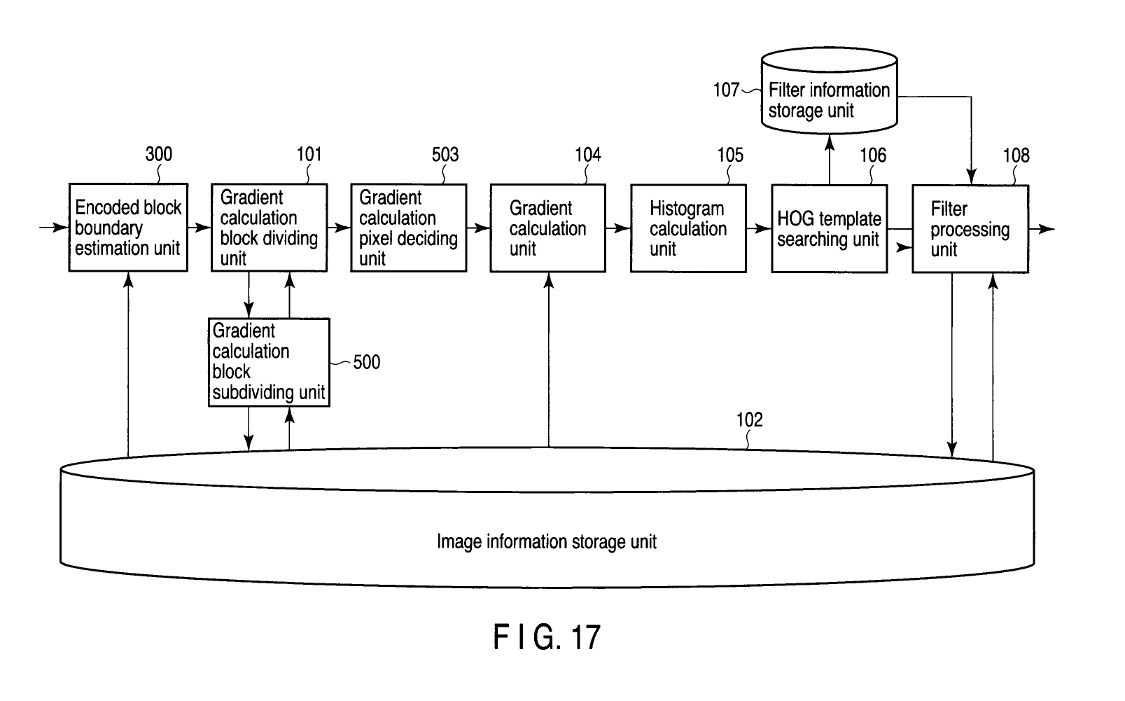

As shown in FIG. 17, an image processing apparatus according to Embodiment C3 of the present invention is formed by adding a gradient calculation block subdividing unit 500 and replacing the gradient calculation pixel deciding unit 303 with a gradient calculation pixel deciding unit 503 in the image processing apparatus in FIG. 14. The same reference numerals as in FIG. 14 denote the same parts in FIG. 17, and different parts will mainly be explained below.

The image processing apparatuses according to Embodiments C1 and C2 described above decide a representative pixel (gradient calculation pixel) from a gradient calculation block having a fixed size, and select, based on the HOGs of the representative pixel and neighboring pixels, filter information to be applied to the constituent pixels of the gradient calculation block. However, if a region with high luminance gradient such as an edge region or a texture region is included in or around a gradient calculation block, filter information is preferably selected for a finer unit (e.g., for each pixel).

Based on the luminance value distribution in and around a gradient calculation block, the gradient calculation block subdividing unit 500 subdivides the gradient calculation block as needed. More specifically, the gradient calculation block subdividing unit 500 compares a threshold with the luminance difference between the maximum luminance value and the minimum luminance value in and around the gradient calculation block, thereby determining whether the region in and around the gradient calculation block is a flat region (a region where the luminance distribution is flat) or a non-flat region (a region where the luminance distribution is not flat). If the region in and around the gradient calculation block is a non-flat region, the gradient calculation block subdividing unit 500 subdivides the gradient calculation block into, e.g., pixels. The gradient calculation pixel deciding unit 503 switches processing in accordance with the size of the input gradient calculation block (or the presence/absence of subdivision), and decides the gradient calculation pixel.

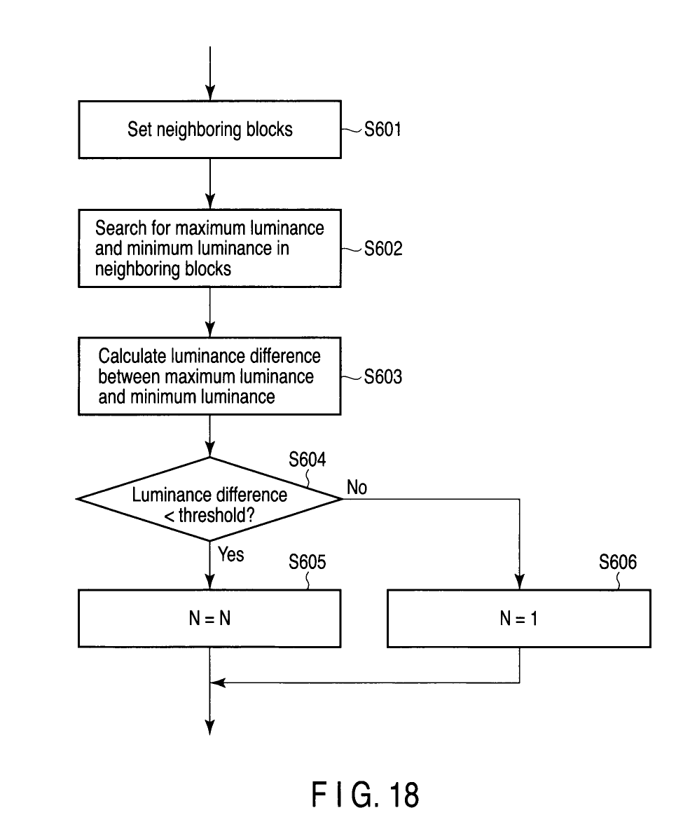

Note that the processing of the image processing apparatus shown in FIG. 17 is implemented by replacing the process of step S202 in FIG. 13 with processing shown in FIG. 15, and inserting processing shown in FIG. 18 immediately after the process of step S201 in FIG. 13. Processing executed by the gradient calculation block subdividing unit 500 in FIG. 17 will be described below with reference to FIG. 18.

The gradient calculation block subdividing unit 500 sets the process target gradient calculation block and blocks around it as neighboring blocks (step S601). Note that the neighboring blocks preferably include all pixels that can be referred to in filter processing for all constituent pixels of the gradient calculation block. More specifically, let 2R+1 be the tap length of the filter, and 33 N be the size of the gradient calculation block. In this case, the size of a neighboring block is preferably (2R+N)×(2R+N) or more.

Next, the gradient calculation block subdividing unit 500 searches for the maximum and minimum luminance values in the neighboring blocks (step S602). The gradient calculation block subdividing unit 500 calculates the luminance difference between the maximum luminance value and the minimum luminance value found in step S602 (step S603), and compares it with a threshold (step S604). If the luminance difference is smaller than the threshold, the process advances to step S605. Otherwise, the process advances to step S606. In other words, if the neighboring blocks form a flat region, the process advances to step S605. Otherwise, the process advances to step S606.

In step S605, the gradient calculation block subdividing unit 500 maintains the current size of the gradient calculation block, and the processing in FIG. 18 ends. In step S606, the gradient calculation block subdividing unit 500 subdivides the gradient calculation block into pixels, and the processing in FIG. 18 ends.

As described above, the image processing apparatus according to this embodiment divides a gradient calculation block more finely in accordance with the luminance distribution in the neighboring blocks, instead of uniformly dividing an image signal into gradient calculation blocks in a fixed size. Hence, according to the image processing apparatus of the embodiment, if the neighboring blocks form a non-flat region, appropriate filter information is selected for, e.g., each pixel. It is therefore possible to suppress image quality degradation caused upon smoothing an edge region, texture region, or the like.

Note that the present invention is not exactly limited to the above embodiments, and constituent elements can be modified in the stage of practice without departing from the spirit and scope of the invention. Various inventions can be formed by properly combining a plurality of constituent elements disclosed in the above embodiments. For example, several constituent elements may be omitted from all the constituent elements described in the embodiments. In addition, constituent elements throughout different embodiments may be properly combined.

For example, the program for implementing the processing of the above-described embodiments can be stored in a computer-readable storage medium and provided. Examples of the storage medium are a magnetic disk, optical disk (e.g., CD-ROM, CD-R, and DVD), magnetooptical disk (e.g., MO), and semiconductor memory, and any other computer-readable storage medium capable of storing a program is usable irrespective of storage form.

The program for implementing the processing of the above-described embodiments may be stored on a computer (server) connected to a network such as the Internet and downloaded to a computer (client) via the network.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a decoding unit configured to decode a coded stream to obtain pixel data of pixels included in a frame;
a filter coefficient deciding unit configured to obtain, for each pixel data, a filter coefficient to be used for filtering of the pixel data by multiplying the pixel data and pixel data located around the pixel data by filter coefficients, respectively, and adding multiplication results;
a determination unit configured to determine, based on the filter coefficient to multiply pixel data of a target pixel of the filtering, effectiveness of adaptive control of the filter coefficient to be used in the filtering;
a filter coefficient reconstruction unit configured to adaptively control and output the filter coefficient to be used for the filtering for each pixel data if the determination unit has determined that the effectiveness is high, or output the filter coefficient obtained by the filter coefficient deciding unit if the determination unit has determined that the effectiveness is not high; and
a filtering unit configured to filter the pixel data using the filter coefficient output from the filter coefficient reconstruction unit.

2. The apparatus according to claim 1, wherein
the determination unit determines, based on the filter coefficient to multiply the pixel data of the target pixel of the filtering, whether the filtering has high edge preservation, and
if the determination unit has determined that the filtering has no high edge preservation, the filter coefficient reconstruction unit adaptively controls the filter coefficient in accordance with a luminance difference between the pixel data of the target pixel and pixel data of a pixel near the target pixel.

3. The apparatus according to claim 1, wherein
if the filter coefficient to multiply the pixel data of the target pixel of the filtering is larger than a preset threshold, the determination unit determines that the effectiveness of adaptive control of the filter coefficient to be used in the filtering is high.

4. The apparatus according to claim 1, wherein the determination unit obtains a weighted sum of the filter coefficient to multiply the pixel data of the target pixel of the filtering and a filter coefficient to multiply pixel data of a pixel located around the target pixel, and if the weighted sum is larger than a preset threshold, determines that the effectiveness of adaptive control of the filter coefficient to be used in the filtering is high.

5. An image processing method comprising the steps of:
decoding a coded stream to obtain pixel data of pixels included in a frame;
obtaining, for each pixel data, a filter coefficient to be used for filtering of the pixel data by multiplying the pixel data and pixel data located around the pixel data by filter coefficients, respectively, and adding multiplication results;
determining, based on a filter coefficient to multiply pixel data of a target pixel of the filtering, effectiveness of adaptive control of the filter coefficient to be used in the filtering;
adaptively controlling and outputting the filter coefficient to be used for the filtering for each pixel data if it has been determined in the determining step that the effectiveness is high, or outputting the filter coefficient obtained in the step of obtaining a filter coefficient if it has been determined in the determining step that the effectiveness is not high; and
filtering the pixel data using the filter coefficient output in the step of outputting the filter coefficient.

6. The method according to claim 5, wherein
in the determining step, it is determined, based on the filter coefficient to multiply the pixel data of the target pixel of the filtering, whether the filtering has high edge preservation, and
if it has determined in the determining step that the filtering has no high edge preservation, the filter coefficient is adaptively controlled in the step of outputting a filter coefficient in accordance with a luminance difference between the pixel data of the target pixel and pixel data of a pixel near the target pixel.

7. The method according to claim 5, wherein
if the filter coefficient to multiply the pixel data of the target pixel of the filtering is larger than a preset threshold, it is determined in the determining step that the effectiveness of adaptive control of the filter coefficient to be used in the filtering is high.

8. The method according to claim 5, wherein in the determining step, a weighted sum of the filter coefficient to multiply the pixel data of the target pixel of the filtering and a filter coefficient to multiply pixel data of a pixel located around the target pixel is obtained, and if the weighted sum is larger than a preset threshold, it is determined that the effectiveness of adaptive control of the filter coefficient to be used in the filtering is high.

9. An image processing apparatus for performing filtering for each block included in a frame, comprising:
a texture feature amount detection unit configured to obtain, for each block, a texture feature amount representing complexity of an image; and
a filtering unit configured to, based on the texture feature amount detected by the texture feature amount detection unit, perform filtering of image data of each block using a first filter if the complexity of the image of the block does not exceed a threshold, and perform filtering of image data of each block using a second filter obtained by reconstructing the first filter if the complexity of the image of the block exceeds the threshold.

10. The apparatus according to claim 9, wherein the texture feature amount detection unit detects a maximum value and a minimum value of luminance values in each block, and obtains a difference between the maximum value and the minimum value as the texture feature amount representing the complexity of the image.

11. The apparatus according to claim 9, wherein the texture feature amount detection unit obtains a variance of luminance values in each block, and obtains the variance as the texture feature amount representing the complexity of the image.

12. The apparatus according to claim 9, wherein the texture feature amount detection unit detects a difference between a maximum value and a minimum value of luminance values in each block, obtains a variance of the luminance values in each block, and obtains a value based on the difference and the variance as the texture feature amount representing the complexity of the image.

13. The apparatus according to claim 9, wherein the texture feature amount detection unit detects a maximum value and a minimum value of color differences in each block, and obtains a difference between the maximum value and the minimum value as the texture feature amount representing the complexity of the image.

14. The apparatus according to claim 9, wherein the texture feature amount detection unit detects a variance of color differences in each block, and obtains the variance as the texture feature amount representing the complexity of the image.

15. The apparatus according to claim 9, wherein the texture feature amount detection unit detects a difference between a maximum value and a minimum value of color differences in each block, obtains a variance of the color differences in each block, and obtains a value based on the difference and the variance as the texture feature amount representing the complexity of the image.

16. The apparatus according to claim 9, wherein the texture feature amount detection unit detects a difference between a maximum value and a minimum value of luminance values in each block, obtains a variance of color differences in each block, and obtains a value based on the difference and the variance as the texture feature amount representing the complexity of the image.

17. The apparatus according to claim 9, wherein the texture feature amount detection unit detects a difference between a maximum value and a minimum value of color differences in each block, obtains a variance of luminance values in each block, and obtains a value based on the difference and the variance as the texture feature amount representing the complexity of the image.

18. The apparatus according to claim 9, which further comprises an image data storage unit configured to store image data of a past frame temporally earlier than a process target frame, and
in which the texture feature amount detection unit obtains the texture feature amount based on a block of the process target frame and a block of the past frame at the same position as the block of the process target frame.

19. The apparatus according to claim 9, which further comprises a texture feature amount storage unit configured to store, as a first texture feature amount, a texture feature amount of a past frame temporally earlier than a process target frame, the texture feature amount being obtained by the texture feature amount detection unit, and
in which the texture feature amount detection unit obtains a second texture feature amount based on a block of the process target frame, and obtains the texture feature amount based on the second texture feature amount and the first texture feature amount stored in the texture feature amount storage unit.

20. The apparatus according to claim 9, wherein the filtering unit performs filtering of image data of each block using the second filter obtained by reconstructing the first filter using an E filter if the complexity of the image of the block exceeds the threshold.

21. The apparatus according to claim 9, wherein the filtering unit performs filtering of image data of each block using the second filter obtained by reconstructing the first filter using a bilateral filter if the complexity of the image of the block exceeds the threshold.

22. The apparatus according to claim 9, wherein after the texture feature amount detection unit has obtained the texture feature amount for all blocks of a process target frame, the filtering unit performs filtering based on the texture feature amount.

23. The apparatus according to claim 9, wherein the texture feature amount detection unit obtains the texture feature amount representing the complexity of the image based on image data in a block size.

24. The apparatus according to claim 9, wherein the texture feature amount detection unit obtains the texture feature amount representing the complexity of the image based on image data in a size different from a block size.

25. The apparatus according to claim 9, which further comprises:
a filter storage unit configured to store a filter and a feature amount of an edge included in the block in association with each other;
an edge feature amount detection unit configured to detect an edge feature amount in each block; and
a filter selection unit configured to select a filter for each block based on the detected edge feature amount, and
in which based on the texture feature amount detected by the texture feature amount detection unit, the filtering unit performs filtering of image data of each block using the filter selected by the filter selection unit if the complexity of the image of the block does not exceed the threshold, and performs filtering of image data of each block using a filter obtained by reconstructing the filter selected by the filter selection unit if the complexity of the image of the block exceeds the threshold.

26. An image processing apparatus comprising:
a dividing unit configured to divide an image signal into a plurality of gradient calculation blocks;
a deciding unit configured to decide one gradient calculation pixel from pixels included in the gradient calculation block;
a first calculation unit configured to calculate gradient intensities and gradient angles of pixels belonging to a region including the gradient calculation pixel;
a second calculation unit configured to calculate a histogram based on the gradient intensities and the gradient angles;
a searching unit configured to search a storage unit for a histogram template most similar to the histogram, the storage unit storing a plurality of histogram templates and a plurality of pieces of filter information in association with each other; and
a processing unit configured to perform filter processing of a pixel included in the gradient calculation block using filter information corresponding to the found histogram template.

27. The apparatus according to claim 26, which further comprises an estimation unit configured to estimate encoded block boundaries of the image signal, and
in which the gradient calculation block is a rectangular block including an even number of pixels in at least one of a horizontal direction and a vertical direction, and
the deciding unit searches for an intersection of the encoded block boundaries closest to the gradient calculation block, and decides, out of a plurality of pixels adjacent to central coordinates of the gradient calculation block, a pixel farthest from the intersection of the encoded block boundaries as the gradient calculation pixel.

28. The apparatus according to claim 26, wherein the gradient calculation block is a rectangular block including an odd number of pixels in each of a horizontal direction and a vertical direction, and
the deciding unit decides a central pixel of the gradient calculation block as the gradient calculation pixel.

29. The apparatus according to claim 26, further comprising a subdividing unit configured to more finely divide the gradient calculation block if a luminance difference between a maximum luminance value and a minimum luminance value in a region including the gradient calculation block is not less than a threshold.

30. An image processing method comprising:
dividing an image signal into a plurality of gradient calculation blocks;
deciding one gradient calculation pixel from pixels included in the gradient calculation block;
calculating gradient intensities and gradient angles of pixels belonging to a region including the gradient calculation pixel;
calculating a histogram based on the gradient intensities and the gradient angles;
searching a storage unit for a histogram template most similar to the histogram, the storage unit storing a plurality of histogram templates and a plurality of pieces of filter information in association with each other; and
performing filter processing of a pixel included in the gradient calculation block using filter information corresponding to the found histogram template.
